(19) United States
(12) Patent Application Publication
(10) Pub. No.: US 2026/0118725 A1
(43) Pub. Date: Apr. 30, 2026

(54) WIRING SUBSTRATE AND DISPLAY DEVICE

(71) Applicant: Sharp Display Technology Corporation, Kameyama City (JP)

(72) Inventor: Hidetoshi NAKAGAWA, Kameyama City (JP)

(21) Appl. No.: 19/357,385

(22) Filed: Oct. 14, 2025

(30) Foreign Application Priority Data
Oct. 29, 2024 (JP) 2024-189787

(51) Int. Cl. G02F 1/1362; G02F 1/1368; G09G 3/36

(52) U.S. Cl. CPC G02F 1/136263; G02F 1/136204; G02F 1/13629; G02F 1/1368; G09G 3/3677; G09G 2310/0286

(57) ABSTRACT

A wiring substrate includes a first line including first and second line portions, a first conductive portion crossing the second line portion at a first crossing portion, a second line spaced from the first line in a first direction and including third and fourth line portions, and a second conductive portion crossing the fourth line portion at a second crossing portion. The first line portion includes a first end portion connected to a second end portion of the second line portion. The third line portion includes a third end portion connected to a fourth end portion of the fourth line portion. A first distance is between the third end portion and the first end portion in the first direction. A second distance is between the second crossing portion and the first crossing portion in the first direction. The second distance differs from the first distance.

### CROSS REFERENCE TO RELATED APPLICATION

This application claims priority from Japanese Patent Application No. 2024-189787 filed on Oct. 29, 2024. The entire contents of the priority application are incorporated herein by reference.

### TECHNICAL FIELD

The present technology described herein relates to a wiring substrate and a display device with which short circuits are less likely to occur.

### BACKGROUND

As an example of a wiring substrate included in a liquid crystal display device, an active matrix substrate (a semiconductor device) has been known. Such an active matrix substrate includes a first line having a first end portion, a second line having a second end portion and being insulated from the first line, a first conductive portion that is disposed adjacent to and spaced from the first end portion and the second end portion, an insulation layer covering the first line, the second line, and the first conductive portion, and a second conductive portion disposed on the insulation layer. The insulation layer includes a first contact hole that overlaps the first end portion and a second contact hole that overlaps the first conductive portion. The second conductive portion is connected to the first end portion and the first conductive portion via the first contact hole and the second contact hole, respectively. The second end portion is insulated from the first conductive portion. The first conductive portion includes a projecting portion projecting toward the first end portion. The insulation layer includes a first hole that overlaps the projecting portion of the first conductive portion.

In such an active matrix substrate, the end portion of the gate line that is connected to a gate extending line via a third contact hole and the crossing portion of the gate extending line and the CS main section are on a same straight line. A distance between the end portion of the gate line and the crossing portion of the gate extending line and the CS main section is quite short. Therefore, if electrostatic discharge (ESD) occurs, a pin hole is likely to be created near the crossing portion of the gate extending line and the CS main section and a short circuit is likely to occur between the gate extending line and the CS main section.

### SUMMARY

The technology described herein was made in view of the above circumstances. An object is to suppress occurrence of short circuits.
(1) A wiring substrate according to the technology described herein includes a first line, a first conductive portion that crosses a portion of the first line, a second line that is disposed to be spaced from the first line with respect to a first direction, and a second conductive portion that crosses a portion of the second line. The first line includes a first line portion that is a portion of a first conductive film and a second line portion that is a portion of a second conductive film with having a first insulating film between the first conductive film and the second conductive film. The first line portion includes a first end portion. The second line portion includes a second end portion that is connected to the first end portion. The first conductive portion is a portion of the first conductive film. The first conductive portion crosses the second line portion of the first line at a first crossing portion. The second line includes a third line portion that is a portion of the first conductive film and a fourth line portion that is a portion of the second conductive film. The third line portion includes a third end portion that is away from the first end portion in the first direction with having a first distance between the third end portion and the first end portion. The fourth line portion includes a fourth end portion that is connected to the third end portion. The second conductive portion is a portion of the first conductive film. The second conductive portion crosses the fourth line portion of the second line at a second crossing portion. The fourth line portion includes the second crossing portion that is away from the first crossing portion in the first direction with having a second distance between the second crossing portion and the first crossing portion. The second distance differs from the first distance.
(2) The wiring substrate may further include, in addition to (1), a third line that is spaced from the second line to be away from the first line in the first direction, and a third conductive portion that crosses a portion of the third line. The third line may include a fifth line portion that is a portion of the first conductive film and a sixth line portion that is a portion of the second conductive film. The fifth line portion may include a fifth end portion that is away from the third end portion in the first direction with having a third distance between the fifth end portion and the third end portion. The sixth line portion may include a sixth end portion that is connected to the fifth end portion. The third conductive portion may be a portion of the first conductive film. The third conductive portion may crosse the sixth line portion of the third line at a third crossing portion. The sixth line portion may include the third crossing portion that is away from the second crossing portion in the first direction with having a fourth distance between the second crossing portion and the third crossing portion. The fourth distance may differ from the third distance.
(3) In the wiring substrate, in addition to (2), the first line, the second line, and the third line may be arranged such that the first distance differs from the third distance and the second distance is equal to the fourth distance.
(4) The wiring substrate may further include, in addition to (3), a fourth conductive portion that is a portion of the second conductive film and continuous to the second line portion, a fifth conductive portion that is a portion of the second conductive film and continuous to the fourth line portion and spaced from the fourth conductive portion in the first direction, and a sixth conductive portion that is a portion of the second conductive film and continuous to the sixth line portion and spaced from the fifth conductive portion to be away from the fourth conductive portion in the first direction. The first end portion and the second end portion of the first line may be disposed locally in an area corresponding to the fourth conductive portion to be away from the fifth conductive portion with respect to the first direction. The third end portion and the fourth end portion of the second line may be disposed locally in an area corresponding to the fifth conductive portion to be away from the fourth conductive portion with respect to the first direction. The fifth end portion and the sixth end portion of the third line may be disposed locally in an area corresponding to the sixth conductive portion to be close to the fifth conductive portion with respect to the first direction.
(5) In the wiring substrate, in addition to (2), the first line, the second line, and the third line may be arranged such that the first distance differs from the third distance and the second distance differs from the fourth distance.
(6) The wiring substrate may further include, in addition to (5), a fourth conductive portion that is a portion of the second conductive film and continuous to the second line portion, a fifth conductive portion that is a portion of the second conductive film and continuous to the fourth line portion and spaced from the fourth conductive portion in the first direction, and a sixth conductive portion that is a portion of the second conductive film and continuous to the sixth line portion and spaced from the fifth conductive portion to be away from the fourth conductive portion in the first direction. The first end portion and the second end portion of the first line may be disposed locally in an area corresponding to the fourth conductive portion to be away from the fifth conductive portion with respect to the first direction and the first line may be disposed such that the first crossing portion is disposed locally in the area corresponding to the fourth conductive portion to be closer to the fifth conductive portion with respect to the first direction. The third end portion and the fourth end portion of the second line may be disposed locally in an area corresponding to the fifth conductive portion to be away from the fourth conductive portion with respect to the first direction and the second line may be disposed such that the second crossing portion is disposed locally in the area corresponding to the fifth conductive portion to be closer to the fourth conductive portion with respect to the first direction. The fifth end portion and the sixth end portion of the third line may be disposed locally in an area corresponding to the sixth conductive portion to be close to the fifth conductive portion with respect to the first direction and the third line may be disposed such that the third crossing portion is disposed locally in the area corresponding to the sixth conductive portion to be away from the fifth conductive portion with respect to the first direction.
(7) In the wiring substrate, in addition to (5) or (6), the first line portion may include a first bent portion that extends from the first end portion along a second direction crossing the first direction to be away from the first conductive portion and is subsequently bent to extend along the first direction, and a first extending portion that extends from an end of the first bent portion along the second direction to be away from the first end portion. The third line portion may include a second bent portion that extends from the third end portion along the second direction to be away from the second conductive portion and is subsequently bent to extend along the first direction, and a second extending portion that extends from an end of the second bent portion along the second direction to be away from the third end portion. The fifth line portion may include a third bent portion that extends from the fifth end portion along the second direction to be away from the third conductive portion and is subsequently bent to extend along the first direction, and a third extending portion that extends from an end of the third bent portion along the second direction to be away from the fifth end portion. The first line portion, the third line portion, and the fifth line portion may be disposed such that a fifth distance between the first extending portion and the second extending portion with respect to the first direction and a sixth distance between the second extending portion and the third extending portion with respect to the first direction are same.
(8) In the wiring substrate, in addition to (2), the first line, the second line, and the third line may be arranged such that the second distance differs from the fourth distance and the first distance and the third distance are same.
(9) The wiring substrate may further include, in addition to (8), a fourth conductive portion that is a portion of the second conductive film and continuous to the second line portion, a fifth conductive portion that is a portion of the second conductive film and continuous to the fourth line portion and spaced from the fourth conductive portion in the first direction, and a sixth conductive portion that is a portion of the second conductive film and continuous to the sixth line portion and spaced from the fifth conductive portion to be away from the fourth conductive portion in the first direction. The first line may be disposed such that the first crossing portion is disposed locally in an area corresponding to the fourth conductive portion to be closer to the fifth conductive portion with respect to the first direction. The second line may be disposed such that the second crossing portion is disposed locally in an area corresponding to the fifth conductive portion to be closer to the fourth conductive portion with respect to the first direction. The third line may be disposed such that the third crossing portion is disposed locally in an area corresponding to the sixth conductive portion to be away from the fifth conductive portion with respect to the first direction.
(10) The wiring substrate may further include, in addition to any one of (1) to (9), a shift resistor circuit that includes a first unit circuit connected to the second line portion and a second unit circuit connected to the fourth line portion. The first unit circuit may include the first conductive portion and the second unit circuit may include the second conductive portion. The first conductive portion and the second conductive portion may be arranged at an interval in the first direction.
(11) In the wiring substrate, in addition to (10), the first conductive portion may include a first projection portion that projects toward the first end portion in a second direction that crosses the first direction. A distance between the first projection portion and the first end portion may be shorter than a distance between the first crossing portion and the first end portion. The second conductive portion may include a second projection portion that projects toward the third end portion in the second direction. A distance between the second projection portion and the third end portion may be shorter than a distance between the second crossing portion and the third end portion.
(12) The wiring substrate may further include, in addition to any one of (1) to (9), a shift resistor circuit that includes a first unit circuit connected to the second line portion and a second unit circuit connected to the fourth line portion, and a fourth line that extends along the first direction between the shift resistor circuit and the each of the first end portion and the third end portion with respect to a second direction crossing the first direction. The fourth line may be a portion of the first conductive film. The first conductive portion may be a portion of the fourth line that crosses the second line portion. The second conductive portion may be a portion of the fourth line that crosses the fourth line portion.
(13) In the wiring substrate, in addition to (12), the fourth line may include wide sections that project toward the first end portion and the third end portion. One of the wide sections projecting toward the first end portion may be closer to the first end portions than the first crossing portion is and another one of the wide sections projecting toward the third end portion may be closer to the third end portion than the second crossing portion is.
(14) A display device according to the technology described herein includes the wiring substrate according to any one of (1) to (13), and an opposed substrate disposed to face and spaced from the wiring substrate.

According to the technology described herein, short circuits are less likely to occur.

### BRIEF DESCRIPTION OF THE DRAWINGS

FIG. 1 is a plan view illustrating a liquid crystal panel, a driver, and a flexible substrate according to a first embodiment.

FIG. 2 is a cross-sectional view illustrating the liquid crystal panel, the driver, and the flexible substrate according to the first embodiment.

FIG. 3 is a plan view illustrating pixel arrangement of the liquid crystal panel according to the first embodiment.

FIG. 4 is a cross-sectional view of a pixel TFT included in a display area of an array substrate of the liquid crystal panel according to the first embodiment.

FIG. 5 is a plan view illustrating a shift resistor circuit and a gate line included in the array substrate according to the first embodiment.

FIG. 6 is a cross-sectional view of the array substrate according to the first embodiment along vi-vi line in FIG. 5.

FIG. 7 is a plan view illustrating a shift resistor circuit and a gate line included in an array substrate according to a second embodiment.

FIG. 8 is a plan view illustrating a shift resistor circuit and a gate line included in an array substrate according to a third embodiment.

FIG. 9 is a plan view illustrating a shift resistor circuit and a gate line included in an array substrate according to a fourth embodiment.

FIG. 10 is a plan view illustrating a shift resistor circuit and a gate line included in an array substrate according to a fifth embodiment.

FIG. 11 is a plan view illustrating a liquid crystal panel, a driver, and a flexible substrate according to a sixth embodiment.

FIG. 12 is a plan view illustrating a shift resistor circuit and a gate line included in an array substrate according to the sixth embodiment.

FIG. 13 is a cross-sectional view of the array substrate according to the sixth embodiment along Xiii-Xiii line in FIG. 12.

FIG. 14 is a plan view illustrating a shift resistor circuit and a gate line included in an array substrate according to a seventh embodiment.

FIG. 15 is a cross-sectional view illustrating a connection configuration of a gate body portion and a gate extending portion of an array substrate according to an eighth embodiment.

FIG. 16 is a cross-sectional view illustrating a connection configuration of a gate body portion and a gate extending portion of an array substrate according to a ninth embodiment.

### DETAILED DESCRIPTION

### First Embodiment

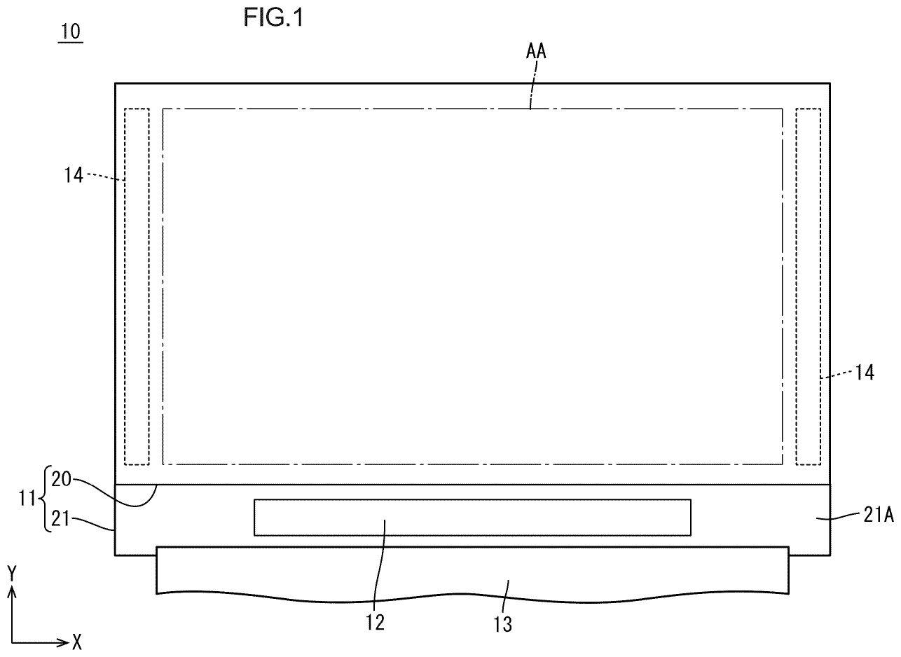

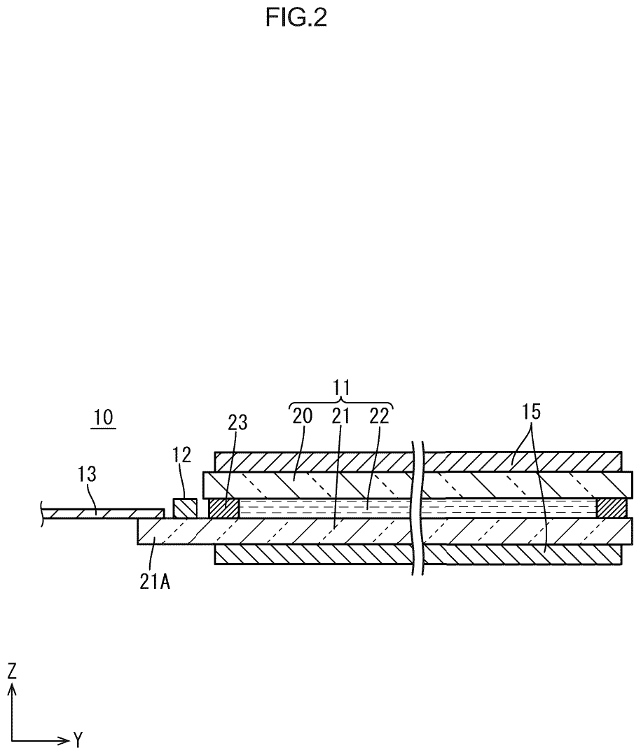

A first embodiment will be described with reference to FIGS. 1 to 6. In this embodiment section, a liquid crystal display apparatus 10 will be described. X-axes, Y-axes, and Z-axes may be present in the drawings. The axes in each drawing correspond to the respective axes in other drawings. An upper side and a lower side in FIGS. 2, 4, and 6 correspond to a front side and a back side, respectively.

As illustrated in FIG. 1, the liquid crystal display apparatus 10 at least includes a liquid crystal panel 11 (a display device, a display panel) that has a laterally long rectangular plan view shape and displays an image and a backlight unit (a lighting device) that supplies light to the liquid crystal panel 11 for displaying. The backlight unit is disposed behind (on a back surface side of) the liquid crystal panel 11. The backlight unit includes light sources configured to emit white light (e.g., LEDs) and optical members for converting the light from the light sources into planar light by applying optical effects to the light from the light sources. A middle section of a plate surface of the liquid crystal panel 11 is configured as a display area AA in which images are displayed. An outer section in a frame shape surrounding the display area AA on the plate surface of the liquid crystal panel 11 is configured as a non-display area NAA in which the images are not displayed.

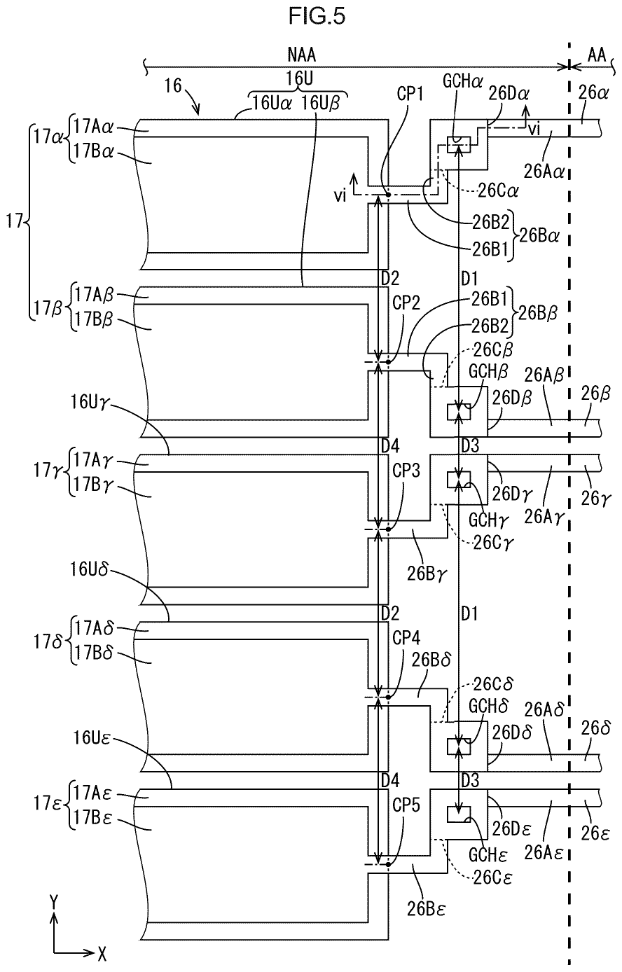

As illustrated in FIG. 1, gate driver circuits 14 are disposed in the non-display area NAA of the liquid crystal panel 11. A pair of gate driver circuits 14 are disposed to sandwich the display area AA with respect to the X-axis direction. The gate driver circuit 14 is disposed in a belt shape area extending in the Y-axis direction. The gate driver circuits 14 are for supplying scan signals to gate lines 26, which will be described later, and are monolithically fabricated on an array substrate 21. The gate driver circuit 14 is a gate driver monolithic (GDM) circuit. The gate driver circuit 14 includes a shift resister circuit 16 that is configured to output a scanning signal at a predefined timing and a buffer circuit that is configured to amplify scanning signals (refer to FIG. 5). The shift resistor circuit 16 will be described later.

The liquid crystal panel 11 will be described in detail with reference to FIGS. 1 and 2. As illustrated in FIGS. 1 and 2, the liquid crystal panel 11 includes a pair of substrates 20, 21 that are bonded to each other. One of the substrates 20, 21 on the front side is an opposed substrate 20 and another one on the back side is an array substrate 21 (a wiring substrate). The opposed substrate 20 and the array substrate 21 include glass substrates and various kinds of films that are formed in layers on an inner surface side of the glass substrates. A liquid crystal layer 22 is disposed between the substrates 20 and 21. The liquid crystal layer 22 includes liquid crystal molecules having optical characteristics that vary according to application of electric field. A sealing portion 23 is disposed between the outer peripheral portions of the substrates 20, 21 for sealing the liquid crystal layer 22. The sealing portion 23 is formed in a square frame shape and surrounds the liquid crystal layer 22. Polarizing plates 15 are attached to outer surfaces of the substrates 20 and 21.

As illustrated in FIGS. 1 and 2, the opposed substrate 20 has a short-side dimension that is smaller than a short-side dimension of the array substrate 21. The opposed substrate 20 is bonded to the array substrate 21 such that one of the long sides of the opposed substrate 20 is aligned with a corresponding one of the long sides of the array substrate 21. Therefore, a long side edge section including another one of the long sides of the array substrate 21 projects from another one of the long sides of the opposed substrate 20 and a projecting long side edge section is an uncovered section 21A. An entire area of the uncovered section 21A is the non-display area NAA and a driver 12 and a flexible substrate 13 that are components for supplying various signals are mounted on the uncovered section 21A.

The driver 12 is LSI chips including driver circuits therein. The driver 12 is mounted on the uncovered section 21A of the array substrate 21 through the chip-on-glass (COG) technology. The driver 12 processes the various kinds of signals transmitted from the flexible substrate 13. As illustrated in FIGS. 1 and 2, the driver 12 is disposed on one side of the display area AA with respect to the Y-axis direction and is disposed between the flexible substrate 13 and the display area AA. The driver 12 has a laterally long rectangular plan view shape. The driver 12 supplies various kinds of signals to source lines 27 of the array substrate 21. The flexible substrate 13 includes a substrate made of synthetic resin (e.g., polyimide-based resin) having insulating property and flexibility and multiple traces formed on the substrate. A first end of the flexible substrate 13 is connected to the uncovered section 21A of the array substrate 21 and a second end of the flexible substrate 13 is connected to a external circuit board (such as a control board).

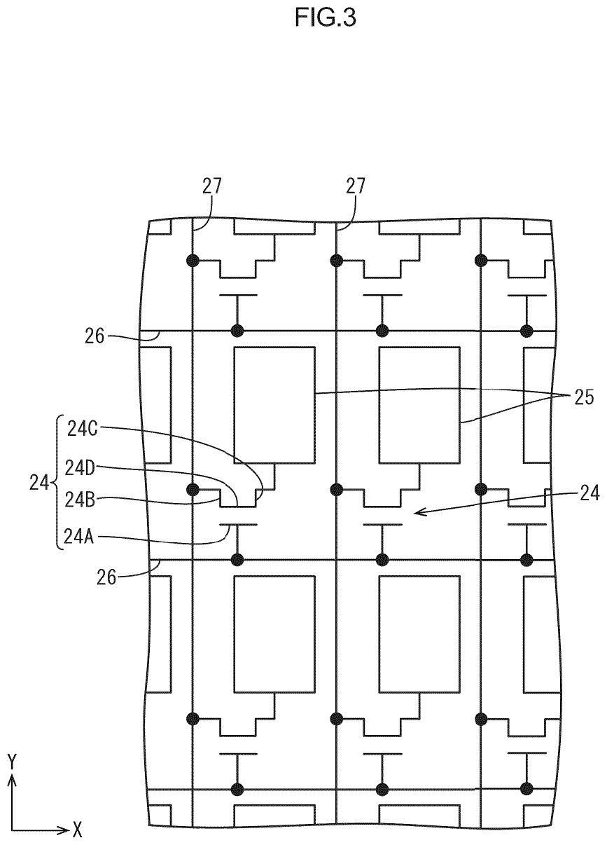

Next, a configuration of the array substrate 21 in the display area AA will be described with reference to FIG. 3. As illustrated in FIG. 3, at least pixel TFTs 24 (transistors, switching components) and pixel electrodes 25 are arranged on an inner surface of the array substrate 21 in the display area AA. The pixel TFTs 24 and the pixel electrodes 25 are arranged at intervals in a matrix (rows and columns) along the X-axis direction and the Y-axis direction. Gate lines 26 (scanning lines) and source lines 27 (image lines, signal lines) are routed perpendicular to each other to surround the pixel TFTs 24 and the pixel electrodes 25. The gate lines 26 extend along the X-axis direction (a second direction crossing a first direction) and are arranged at intervals with respect to the Y-axis direction. The gate lines 26 are arranged at equal intervals such that spaces between the gate lines 26 in the Y-axis direction area same. The source lines 27 extend along the Y-axis direction and are arranged at intervals with respect to the X-axis direction. The source lines 27 are arranged at equal intervals such that spaces between the source lines 27 in the X-axis direction are same.

As illustrated in FIG. 3, the pixel TFT 24 includes a gate electrode 24A connected to the gate line 26, a source electrode 24B connected to the source line 27, a drain electrode 24C connected to the pixel electrode 25, and a semiconductor section 24D connected to the source electrode 24B and the drain electrode 24C and is made of semiconductor material. The pixel TFTs 24 are driven based on scan signals supplied to the gate electrodes 24A through the gate lines 26. The scan signals include a potential higher than the threshold voltage of the pixel TFTs 24. Then, a channel section is created in the semiconductor section 24D. Therefore, electrons move between the source electrode 24B and the drain electrode 24C via the channel section. The potential of the image signal (a data signal) supplied to the source electrode 24B through the source line 27 is supplied to the drain electrode 24C via the semiconductor section 24D. As a result, the pixel electrode 25 is charged at the potential of the image signal. The pixel electrode 25 has a vertically long rectangular plan view shape and is disposed in an area surrounded by the two gate lines 26, which are adjacent to each other at an interval in the Y-axis direction, and the two source lines 27, that are adjacent to each other at an interval in the X-axis direction. The pixel electrodes 25 have a same plan view size (dimensions in the X-axis direction and the Y-axis direction).

Color filters are disposed in the display area AA of the opposed substrate 20 to be opposed to the pixel electrodes 25 on the array substrate 21 side. The color filters that exhibit three different colors of red (R), green (G), blue (B) are arranged repeatedly in a predefined order. The color filter and the corresponding pixel electrode 25 are configured as a pixel of each color (a red pixel, a green pixel, and a blue pixel). The three pixels of the red pixel, the green pixel, and the blue pixel are configured as a display pixel that can exert color display with a predetermined gradation. A light blocking portion (a black matrix) is disposed between the color filters to prevent mixing of colors. Alignment films for orienting the liquid crystal molecules in the liquid crystal layer 22 are formed on innermost surfaces (in an uppermost layer) of the substrates 20 and 21 in contact with the liquid crystal layer 22.

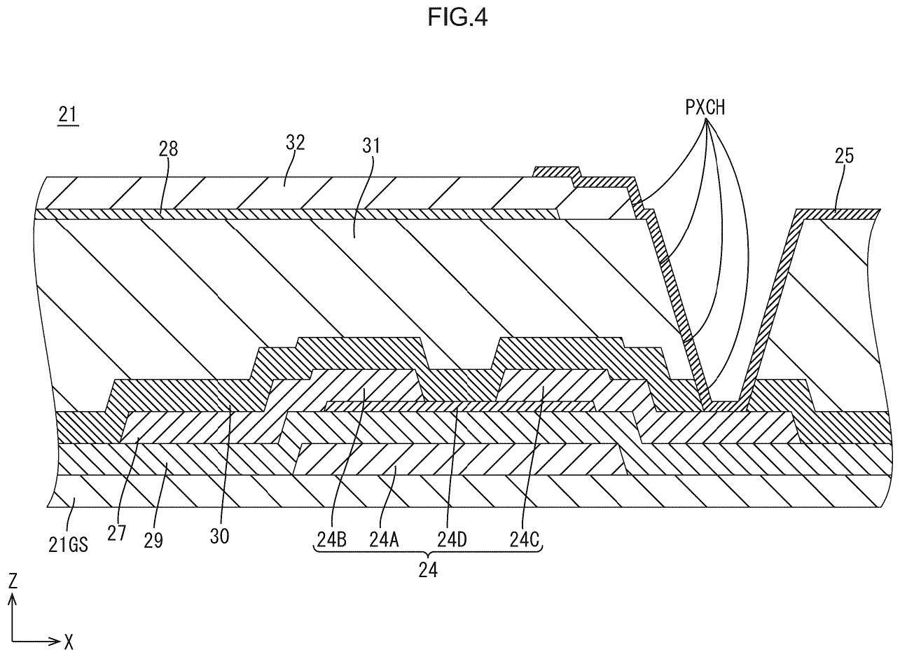

As illustrated in FIG. 4, a common electrode 28 is included in the array substrate 21 so as to overlap the pixel electrode 25 with a space therebetween. The common electrode 28 has a same size as that of the display area AA as a whole. The common electrode 28 is disposed on a lower layer side of all the pixel electrodes 25. The common electrode 28 is supplied with a common potential (a reference potential). In the liquid crystal panel 11, a predefined electric field is applied to the liquid crystal layer 22 based on a potential difference created between the common electrode 28 and each pixel electrode 25 and the pixels perform display with a predetermined gradation. The pixel electrode 25 disposed in a layer upper than the common electrode 28 includes slits. With the pixel electrode 25 being charged at a potential based on the image signal according to the driving of the pixel TFT 24, a potential difference occurs between the pixel electrode 25 and the common electrode 28. Then, a fringe electric field (an oblique electric field) is created between an opening edge of the slit of the pixel electrode 25 and the common electrode 28. The fringe electric field includes a component parallel to the plate surface of the array substrate 21 and a component normal to the plate surface of the array substrate 21. With the fringe electric field, orientations of the liquid crystal molecules included in the liquid crystal layer 22 can be controlled and predefined displaying is performed based on the orientations of the liquid crystal molecules. Namely, the liquid crystal panel 11 according to this embodiment operates in the fringe field switching (FFS) mode.

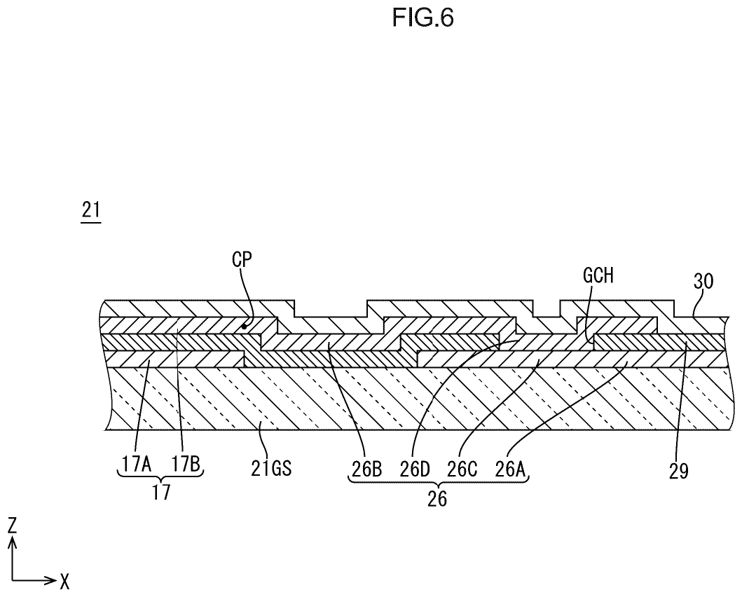

Next, films disposed on top of each other on a glass substrate 21GS (a substrate) of the array substrate 21 will be described with reference to FIG. 4. FIG. 6 illustrates a cross-sectional configuration of the pixel TFT 24. As illustrated in FIG. 4, on the glass substrate 21GS of the array substrate 21, a first metal film (a first conductive film), a gate insulating film 29 (a first insulating film), a semiconductor film, a second metal film (a second conductive film), a first interlayer insulating film 30, a planarization film 31, a first transparent electrode film, a second interlayer insulating film 32, a second transparent electrode film, and an alignment film are disposed on top of each other in this sequence from a lower layer side (from the glass substrate 21GS side).

The first metal film and the second metal film may be a single-layer film made of one kind of metal, a multilayer film made of a material containing different kinds of metals, or an alloy. With such a configuration, the first metal film and the second metal film have electrically conductive properties and light blocking properties. Portions of the first metal film are configured as portions of the gate lines 26 and the gate electrodes 24A of the pixel TFTs 24. Portions of the second metal film are configured as portions of the gate lines 26, the source lines 27, and the source electrodes 24B and the drain electrodes 24C of the pixel TFTs 24. The semiconductor film is made of semiconductor material such as an oxide semiconductor material and amorphous silicon material. Portions of the semiconductor film are configured as the semiconductor sections 24D of the pixel TFTs 24. The first transparent electrode film and the second transparent electrode film are made of a transparent electrode material (e.g., indium tin oxide (ITO) and indium zinc oxide (IZO)). A portion of the first transparent electrode film is configured as the common electrode 28. Portions of the second transparent electrode film are configured as the pixel electrodes 25.

The gate insulating film 29, the first interlayer insulating film 30, and the second interlayer insulating film 32 are made of an inorganic material (inorganic resin material) such as silicon nitride (SiN_{X}) and silicon oxide (SiO₂). The planarization film 31 is an organic insulating film made of an organic material such as PMMA (acrylic resin). The planarization film 31 is much thicker than the gate insulating film 29, the first interlayer insulating film 30, and the second interlayer insulating film 32. The planarization film 31 planarizes the inner surface (a surface opposite the liquid crystal layer 22) of the array substrate 21.

A configuration of the pixel TFTs 24 will be described in detail. As illustrated in FIG. 4, the gate electrode 24A of the pixel TFT 24 is connected to a portion of the gate line 26 near a crossing portion of the gate line 26 that crosses the source line 27. The source electrode 24B of the pixel TFT 24 is connected to a portion of the source line 27 near a crossing portion of the source line 27 that crosses the gate line 26. The drain electrode 24C extends along the X-axis direction and one end portion of the drain electrode 24C (a left end portion in FIG. 4, a portion closer to the source electrode 24B) is connected to the semiconductor section 24D and another one end portion of the drain electrode 24C (a right end portion in FIG. 4) is connected to the pixel electrode 25. The first interlayer insulating film 30, the planarization film 31, and the second interlayer insulating film 32, which are disposed between the drain electrode 24C and the pixel electrode 25, include pixel contact holes PXCH in portions overlapping the drain electrode 24C and the pixel electrode 25. The drain electrode 24C and the pixel electrode 25 are connected to each other via the pixel contact holes PXCH.

As illustrated in FIG. 4, the semiconductor section 24D of the pixel TFT 24 extends along the X-axis direction. The dimension of the semiconductor section 24D measured in the X-axis direction is shorter than that of the gate electrode 24A. The semiconductor section 24D overlaps the gate electrode 24A via the gate insulating film 29. One end portion of the semiconductor section 24D with respect to the X-axis direction is connected to the source electrode 24B and other end portion of the semiconductor section 24D with respect to the X-axis direction is connected to the drain electrode 24C. A channel section is created in the portion of the semiconductor section 24D that is between the source electrode 24B and the drain electrode 24C in the X-axis direction when the pixel TFT 24 is driven. The channel section corresponds to the portion of the semiconductor section 24D that overlaps the gate electrode 24A but not overlap the source electrode 24B and the drain electrode 24C.

The gate insulating film 29 insulates the first metal film in the lower layer from the second metal film in the upper layer. For instance, crossing portions of the gate lines 26, which are portions of the first metal film, and the source lines 27, which are portions of the second metal film, are insulated from each other by the gate insulating film 29. Overlapping portions of the pixel TFTs 24 where the gate electrodes 24A, which are portions of the first metal film, and the semiconductor sections 24D, which are portions of the semiconductor film, are insulated from each other by the gate insulating film 29. The first interlayer insulating film 30 and the planarization film 31 insulate the semiconductor film and the second metal film in the lower layer from the first transparent electrode film in the upper layer. The second interlayer insulating film 32 insulates the first transparent electrode film in the lower layer from the second transparent electrode film in the upper layer. For instance, the common electrode 28, which is a portion of the first transparent electrode film, and the pixel electrodes 25, which are portions of the second transparent electrode film, are insulated from each other by the second interlayer insulating film 32.

Nex, the shift resistor circuit 16 of the gate driver circuit 14 will be described in detail with reference to FIGS. 5 and 6. The shift resistor circuit 16 includes unit circuits 16U illustrated in FIG. 5. The unit circuits 16U are arranged along the Y-axis direction. The unit circuits 16U are connected to various kinds of lines (for instance, a starting pulse line, clock lines, a setting line, a reset line) disposed in the non-display area NAA of the array substrate 21 and are operated based on various kinds of signals (for instance, a starting pulse signal, clock signals, a setting signal, a reset signal) transmitted via the various kinds of lines. The unit circuits 16U are connected to the gate lines 26, respectively, and are operated based on the various kinds of signals to supply scanning signals to the gate lines 26 sequentially from the upper one.

The unit circuits 16U includes non-pixel TFTs and capacitors 17 illustrated in FIG. 5. The non-pixel TFTs included in the unit circuits 16U are disposed with patterning the first metal film, the semiconductor film, and the second metal film similar to the pixel TFTs 24 disposed in the display area AA and have a configuration substantially similar to that of the pixel TFTs 24. The non-pixel TFTs include output TFTs that output signals that are base signals of scanning signals. The capacitor 17 has a potential related to the output signal outputted from the output TFT with bootstrapping and outputting the scanning signal including a potential higher than the threshold voltage of the pixel TFT 24. The capacitor 17 is connected to the gate line 26.

As illustrated in FIG. 6, the capacitor 17 includes a lower layer electrode 17A, which is a portion of the first metal film, and an upper layer electrode 17B, which is a portion of the second metal film. The upper layer electrode 17B overlaps the lower layer electrode 17A. A portion of the gate insulating film 29 is disposed between the lower layer electrode 17A and the upper layer electrode 17B that overlap each other and the overlapping portion functions as dielectric of the capacitor 17. As illustrated in FIG. 5, the lower layer electrode 17A has a plan view size that is larger than that of the upper layer electrode 17B. The lower layer electrode 17A includes an outer peripheral edge portion that is outside the outer peripheral edge of the upper layer electrode 17B and does not overlap the upper layer electrode 17B. Two lower layer electrodes 17A of the two capacitors 17 included in the two unit circuits 16U that are adjacent to each other in the Y-axis direction are arranged at an interval with respect to the Y-axis direction. The lower layer electrodes 17A are arranged at equal intervals in the Y-axis direction. The upper layer electrodes 17B are arranged at equal intervals in the Y-axis direction. The gate lines 26 are, respectively, connected to the upper layer electrodes 17B of the capacitors 17.

Next, the configuration of the gate line 26 connected to the unit circuit 16U will be described in detail with reference to FIGS. 5 and 6. As illustrated in FIG. 5, and 6, the gate line 26 includes a gate body portion 26A and a gate extending portion 26B. The gate body portion 26A extends in the display area AA and the non-display area NAA. The gate extending portion 26B is disposed in the non-display area NAA. The gate body portion 26A extends along the X-axis direction and laterally crosses an entire area of the display area AA and one end portion or both end portions of the gate body portion 26A is/are disposed in the non-display area NAA. Specifically, the gate body portion 26A is a portion of the first metal film and is connected to the gate electrodes 24A of all the pixel TFTs 24 that are arranged along the X-axis direction in the display area AA and configured as one row. An end portion of the gate body portion 26A disposed in the non-display area NAA is a wide section and configured as a body side connection portion 26C that is connected to the gate extending portion 26B.

As illustrated in FIG. 5, one end portion of the gate extending portion 26B is connected to the gate body portion 26A and other end portion is connected to the capacitor 17. Specifically, the gate extending portion 26B is a portion of the second metal film and directly continuous to the upper layer electrode 17B, which is a portion of the second metal film. The gate extending portion 26B extends from the upper layer electrode 17B along the X-axis direction toward the gate body portion 26A (toward the display area AA). The basal portion of the gate extending portion 26B that extends from the upper layer electrode 17B crosses the outer peripheral edge portion of the lower layer electrode 17A that is outside the outer peripheral edge of the upper layer electrode 17B. The gate extending portion 26B crosses the lower layer electrode 17A at a crossing portion CP. The crossing portion CP is at a center of the width of the portion of the gate extending portion 26B crossing the lower layer electrode 17A with respect to a width direction (the Y-axis direction). An end portion of the gate extending portion 26B that is opposite from the upper layer electrode 17B is a wide section and configured as an extending side connection portion 26D that is connected to the gate body portion 26A. The extending side connection portion 26D overlaps the body side connection portion 26C. As illustrated in FIG. 6, the gate insulating film 29 includes a gate contact hole GCH in a portion overlapping the body side connection portion 26C and the extending side connection portion 26D. The body side connection portion 26C and the extending side connection portion 26D are connected via the gate contact hole GCH.

Hereinafter, in FIG. 5, the first one of the unit circuits 16U from the upper end is defined as a first unit circuit 16Uα, the second one is defined as a second unit circuit 16Uβ, the third one is defined as a third unit circuit 16Uγ, the fourth one is defined as a fourth unit circuit 16Uδ, and the fifth one is defined as a fifth unit circuit 16Uε.

Among the capacitors 17 included in the respective unit circuits 16U, one included in the first unit circuit 16Uα is defined as a first capacitor 17α, one included in the second unit circuit 16Uβ is defined as a second capacitor 17β, one included in the third unit circuit 16Uγ is defined as a third capacitor 17γ, one included in the fourth unit circuit 16Uδ is defined as a fourth capacitor 17δ, and one included in the fifth unit circuit 16Uε is defined as a fifth capacitor 17ε.

Among the lower layer electrodes 17A and the upper layer electrodes 17B of the capacitors 17, ones included in the first capacitor 17α are defined as a first lower layer electrode 17Aα (a first conductive portion) and a first upper layer electrode 17Bα (a fourth conductive portion), ones included in the second capacitor 17β are defined as a second lower layer electrode 17Aβ (a second conductive portion) and a second upper layer electrode 17Bβ (a fifth conductive portion), ones included in the third capacitor 17γ are defined as a third lower layer electrode 17Aγ (a third conductive portion) and a third upper layer electrode 17Aγ (a sixth conductive portion), ones included in the fourth capacitor 17δ are defined as a fourth lower layer electrode 17Aδ and a fourth upper layer electrode 17Bδ, and ones included in the fifth capacitor 17ε are defined as a fifth lower layer electrode 17Aε and a fifth upper layer electrode 17Bε. The first lower layer electrode 17Aα and the second lower layer electrode 17Aβ that are adjacent to each other in the Y-axis direction are spaced from each other in the Y-axis direction. The second lower layer electrode 17Aβ and the third lower layer electrode 17Aγ that are adjacent to each other in the Y-axis direction are spaced from each other in the Y-axis direction. The third lower layer electrode 17Aγ and the fourth lower layer electrode 17Aδ that are adjacent to each other in the Y-axis direction are spaced from each other in the Y-axis direction. The fourth lower layer electrode 17Aδ and the fifth lower layer electrode 17Aε that are adjacent to each other in the Y-axis direction are spaced from each other in the Y-axis direction.

Among the gate lines 26, one connected to the first unit circuit 16Uα is defined as a first gate line 26α, one connected to the second unit circuit 16Uβ is defined as a second gate line 26β, one connected to the third unit circuit 16Uγ is defined as a third gate line 26γ, one connected to the fourth unit circuit 16Uδ is defined as a fourth gate line 26δ, and one connected to the fifth unit circuit 16Uε is defined as a fifth gate line 26ε.

Among the gate body portions 26A and the gate extending portions 26B of the gate lines 26, ones included in the first gate line 26α are defined as a first gate body portion 26Aα (a first line portion) and a first gate extending portion 26Bα (a second line portion), ones included in the second gate line 26β are defined as a second gate body portion 26Aβ (a third line portion) and a second gate extending portion 26Bβ (a fourth line portion), ones included in the third gate line 26γ are defined as a third gate body portion 26Aγ (a fifth line portion) and a third gate extending portion 26Aγ (a sixth line portion), ones included in the fourth gate line 26δ are defined as a fourth gate body portion 26Aδ and a fourth gate extending portion 26Bδ, and ones included in the fifth gate line 26ε are defined as a fifth gate body portion 26Aε and a fifth gate extending portion 26Bε.

Among the body side connection portions 26C of the gate body portions 26A, the first gate body portion 26Aα includes a first body side connection portion 26Cα (a first end portion), the second gate body portion 26Aβ includes a second body side connection portion 26Cβ (a third end portion), the third gate body portion 26Aγ includes a third body side connection portion 26Cγ (a fifth end portion), the fourth gate body portion 26Aδ includes a fourth body side connection portion 26Cδ, and the fifth gate body portion 26Aε includes a fifth body side connection portion 26Cε.

Among the extending side connection portions 26D of the gate extending portions 26B, the first gate extending portion 26Bα includes a first extending side connection portion 26Dα (a second end portion), the second gate extending portion 26Bβ includes a second extending side connection portion 26Dβ (a fourth end portion), the third gate extending portion 26Bγ includes a third extending side connection portion 26Dγ (a sixth end portion), the fourth gate extending portion 26Bδ includes a fourth extending side connection portion 26Dδ, and the fifth gate extending portion 26Bε includes a fifth extending side connection portion 26Dε.

Among the gate contact holes GCH, the first body side connection portion 26Cα and the first extending side connection portion 26Dα are connected via a first gate contact hole GCHα (a first contact hole), the second body side connection portion 26Cβ and the second extending side connection portion 26Dβ are connected via a second gate contact hole GCHβ (a second contact hole), the third body side connection portion 26Cγ and the third extending side connection portion 26Dγ are connected via a third gate contact hole GCHγ (a third contact hole), the fourth body side connection portion 26Cδ and the fourth extending side connection portion 26Dδ are connected via a fourth gate contact hole GCHδ, and the fifth body side connection portion 26Cε and the fifth extending side connection portion 26Dε are connected via a fifth gate contact hole GCHε.

Among the crossing portions CP of the gate extending portions 26B and the lower layer electrodes 17A, the first gate extending portion 26Bα crosses the first lower layer electrode 17Aα at a first crossing portion CP1, the second gate extending portion 26Bβ crosses the second lower layer electrode 17Aβ at a second crossing portion CP2, the third gate extending portion 26Bγ crosses the third lower layer electrode 17Aγ at a third crossing portion CP3, the fourth gate extending portion 26Bδ crosses the fourth lower layer electrode 17Aδ at a fourth crossing portion CP4, and the fifth gate extending portion 26Bε crosses the fifth lower layer electrode 17Aε at a fifth crossing point CP5.

The area of the gate body portion 26A of the gate line 26 is larger than that of the lower layer electrode 17A of the unit circuit 16U. Therefore, when patterning the first metal film in the process of producing the array substrate 21, the gate body portion 26A is more likely to be charged than the lower layer electrode 17A. As a result, electrostatic discharge (ESD) may occur between the body side connection portion 26C and the crossing portion CP. If electrostatic breakdown occurs in the crossing portion CP, short circuit may be caused between the gate extending portion 26B and the lower layer electrode 17A.

As illustrated in FIG. 5, the gate extending portion 26B of the gate line 26 is configured such that one end portion (a connection portion of the gate extending portion 26B and the gate body portion 26A) connected to the gate body portion 26A and other end portion (a connection portion of the gate extending portion 26B and the upper layer electrode 17B) connected to the upper layer electrode 17B of the capacitor 17 are at different positions with respect to the Y-axis direction. Specifically, the gate extending portion 26B is bent in an L-shape and has a plan view L-shape. The gate extending portion 26B includes a crossing portion 26B1 that extends along the x-axis direction and crosses the lower layer electrode 17A and an extending portion 26B2 that extends along the Y-axis direction. The crossing portion 26B1 includes the other end portion and is continuous to the upper layer electrode 17B. The extending portion 26B2 extends upward from an end portion opposite from the other end portion (the upper layer electrode 17B side end portion) and includes the one end portion, which is the extending side connection portion 26D.

As illustrated in FIG. 5, the gate extending portions 26B of the two gate lines 26 that are adjacent to and spaced from each other in the Y-axis direction are bent in opposite directions. Namely, the extending portions 26B2 of the two gate lines 26 extend from the end portions of the respective crossing portions 26B1 in opposite directions. Specifically, the first gate extending portion 26Bα of the first gate line 26α extends upward in FIG. 5, the second gate extending portion 26Bβ of the second gate line 26β extends downward in FIG. 5, the third gate extending portion 26Bγ of the third gate line 26γ extends upward in FIG. 5, the fourth gate extending portion 26Bδ of the fourth gate line 26δ extends downward in FIG. 5, and the fifth gate extending portion 26Bε of the fifth gate line 26ε extends upward in FIG. 5. In this embodiment, the first gate line 26α, the third gate line 26γ, and the fifth gate line 26ε have a same plan view shape. The second gate line 26β and the fourth gate line 26δ have a same plan view shape.

Thus, as illustrated in FIG. 5, the gate lines 26 are arranged such that the gate extending portions 26B are bent in opposite directions. Accordingly, a distance between two body side connection portions 26C that are adjacent to each other in the Y-axis direction differs from a distance between two crossing portions CP that are adjacent to each other in the Y-axis direction. Specifically, the first gate body portion 26Aα of the first gate line 26α and the second gate body portion 26Aβ of the second gate line 26β are disposed such that a first distance D1 is between the first body side connection portion 26Cα and the second body side connection portion 26Cβ with respect to the Y-axis direction. On the other hand, the first gate extending portion 26Bα of the first gate line 26α and the second gate extending portion 26Bβ of the second gate line 26β are disposed such that a second distance D2 is between the first crossing portion CP1 and the second crossing portion CP2. The second distance D2 differs from the first distance D1.

In this embodiment, as illustrated in FIG. 5, the second gate body portion 26Aβ of the second gate line 26β and the third gate body portion 26Aγ of the third gate line 26γ are disposed such that a third distance D3 is between the second body side connection portion 26Cβ and the third body side connection portion 26Cγ with respect to the Y-axis direction. On the other hand, the second gate extending portion 26Bβ of the second gate line 26β and the third gate extending portion 26Bγ of the third gate line 26γ are disposed such that a fourth distance D4 is between the second crossing portion CP2 and the third crossing portion CP3 with respect to the Y-axis direction. The fourth distance D4 differs from the third distance D3.

If the gate extending portion 26B extends straight along the X-axis direction or all the gate lines 26 have a same plan view shape, the distance between two body side connection portions 26C that are adjacent to each other in the Y-axis direction and the distance between the two crossing portions CP that are adjacent to each other in the Y-axis direction are same. On the other hand, in this embodiment, the first gate line 26α and the second gate line 26β are configured such that the first distance D1 differs from the second distance D2. Therefore, the straight-line distance between the first body side connection portion 26Cα and the first crossing portion CP1 and the straight-line distance between the second body side connection portion 26Cβ and the second crossing portion CP2 can be long. According to such a configuration, even if the first gate body portion 26Aα and the second gate body portion 26Aβ, which are portions of the first metal film, are charged, electrostatic discharge is less likely to occur between the first body side connection portion 26Cα and the first crossing portion CP1 and electrostatic discharge is less likely to occur between the second body side connection portion 26Cβ and the second crossing portion CP2. Since electrostatic breakdown is less likely to occur in the first crossing portion CP1 and the second crossing portion CP2 due to the electrostatic discharge, short circuit is less likely to be caused between the first gate extending portion 26Bα and the first lower layer electrode 17Aα and short circuit is less likely to be caused between the second gate extending portion 26Bβ and the second lower layer electrode 17Aβ.

In this embodiment, since the second gate line 26β and the third gate line 26γ are configured such that the second distance D2 differs from the third distance D3, a straight-line distance between the third body side connection portion 26Cγ and the third crossing portion CP3 can be longer compared to the configuration in which the distance between two body side connection portions 26C that are adjacent to each other in the Y-axis direction and the distance between the two crossing portions CP that are adjacent to each other in the Y-axis direction are same. According to such a configuration, even if the third gate body portion 26Aγ, which is a portion of the first metal film, is charged, electrostatic discharge is less likely to occur between the third body side connection portion 26Cγ and the third crossing portion CP3. Since electrostatic breakdown is less likely to occur in the third crossing portion CP3 due to the electrostatic discharge, short circuit is less likely to be caused between the third gate extending portion 26Bγ and the third lower layer electrode 17Aγ.

As illustrated in FIG. 5, the third gate body portion 26Aγ of the third gate line 26γ and the fourth gate body portion 26Aδ of the fourth gate line 26δ are disposed such that the first distance D1 is between the third body side connection portion 26Cγ and the fourth body side connection portion 26Cδ with respect to the Y-axis direction. On the other hand, the third gate extending portion 26Bγ of the third gate line 26γ and the fourth gate extending portion 26Bδ of the fourth gate line 26δ are disposed such that the second distance D2 is between the third crossing portion CP3 and the fourth crossing portion CP4 with respect to the Y-axis direction. Namely, the position relation of the third gate line 26γ and the fourth gate line 26δ is same as the position relation of the first gate line 26α and the second gate line 26β.

As illustrated in FIG. 5, the fourth gate body portion 26Aδ of the fourth gate line 26δ and the fifth gate body portion 26Aε of the fifth gate line 26ε are disposed such that the third distance D3 is between the fourth body side connection portion 26Cδ and the fifth gate body side connection portion 26Cε with respect to the Y-axis direction. On the other hand, the fourth gate extending portion 26Bδ of the fourth gate line 26δ and the fifth gate extending portion 26Bε of the fifth gate line 26ε are disposed such that the fourth distance D4 is between the fourth crossing portion CP4 and the fifth crossing portion CP5 with respect to the Y-axis direction. Namely, the position relation of the fourth gate line 26δ and the fifth gate line 26ε is same as the position relation of the second gate line 26β and the third gate line 26γ.

As illustrated in FIG. 5, the first gate line 26α, the second gate line 26β, the third gate line 26γ, the fourth gate line 26δ, and the fifth gate line 26ε are arranged such that the second distance D2 and the fourth distance D4 are same. Specifically, the gate extending portions 26B of all the gate lines 26 are connected to middle portions of the corresponding upper layer electrodes 17B, respectively, with respect to the Y-axis direction. Namely, the position of the gate extending portion 26B with respect to the Y-axis direction substantially matches a middle position of the lower layer electrode 17A with respect to the Y-axis direction. Therefore, the crossing portions CP of the gate extending portions 26B and the lower layer electrodes 17A are disposed at equal intervals in the Y-axis direction. Namely, the second distance D2 between the two crossing portions CP adjacent to each other in the Y-axis direction and the fourth distance D4 between the two crossing portions CP adjacent to each other in the Y-axis direction are same. According to such a configuration, the position relation of the first lower layer electrode 17Aα and the first gate extending portion 26Bα with respect to the Y-axis direction, the position relation of the second lower layer electrode 17Aβ and the second gate extending portion 26Bβ with respect to the Y-axis direction, the position relation of the third lower layer electrode 17Aγ and the third gate extending portion 26Bγ with respect to the Y-axis direction, the position relation of the fourth lower layer electrode 17Aδ and the fourth gate extending portion 26Bδ with respect to the Y-axis direction, and the position relation of the fifth lower layer electrode 17Aε and the fifth gate extending portion 26Bε with respect to the Y-axis direction have a same pattern.

On the other hand, as illustrated in FIG. 5, the first gate line 26α, the second gate line 26β, the third gate line 26γ, the fourth gate line 26δ, and the fifth gate line 26ε are arranged such that the first distance D1 differs from the third distance D3. Specifically, the two gate lines 26 that are adjacent to each other in the Y-axis direction are arranged such that the body side connection portion 26C and the extending side connection portion 26D, which correspond to a connection portion of the gate body portion 26A and the gate extending portion 26B, are at different positions with respect to the Y-axis direction. The body side connection portion 26C and the extending side connection portion 26D of one of the two adjacent gate lines 26 is on one side (an upper side in FIG. 5) in the Y-axis direction with respect to the crossing portion CP (the middle position of the lower layer electrode 17A in the Y-axis direction). The body side connection portion 26C and the extending side connection portion 26D of the other of the two adjacent gate lines 26 is on the other side (a lower side in FIG. 5) in the Y-axis direction with respect to the crossing portion CP. More specifically, the first body side connection portion 26Cα and the first extending side connection portion 26Dα of the first gate line 26α are disposed closer to the edge of the first upper layer electrode 17Bα opposite from the second upper layer electrode 17Bβ side edge with respect to the Y-axis direction. One side edges of the first body side connection portion 26Cα and the first extending side connection portion 26Dα with respect to the Y-axis direction are aligned with one side edge of the first lower layer electrode 17Aα in the Y-axis direction. The second body side connection portion 26Cβ and the second extending side connection portion 26Dβ of the second gate line 26β are disposed closer to the edge of the second upper layer electrode 17Bβ opposite from the first upper layer electrode 17Bα side edge with respect to the Y-axis direction. Other side edges of the second body side connection portion 26Cβ and the second extending side connection portion 26Dβ with respect to the Y-axis direction are aligned with other side edge of the second lower layer electrode 17Aβ in the Y-axis direction.

As illustrated in FIG. 5, the third body side connection portion 26Cγ and the third extending side connection portion 26Dγ of the third gate line 26γ are disposed closer to the second upper layer electrode 17Bβ side edge of the third upper layer electrode 17Bγ with respect to the Y-axis direction. One side edges of the third body side connection portion 26Cγ and the third extending side connection portion 26Dγ with respect to the Y-axis direction are aligned with one side edge of the third lower layer electrode 17Aγ in the Y-axis direction. The fourth body side connection portion 26Cδ and the fourth extending side connection portion 26Dδ of the fourth gate line 26δ are disposed closer to the edge of the fourth upper layer electrode 17Bδ opposite from the third upper layer electrode 17Bγ side edge with respect to the Y-axis direction. Other side edges of the fourth body side connection portion 26Cδ and the fourth extending side connection portion 26Dδ with respect to the Y-axis direction are aligned with other side edge of the fourth lower layer electrode 17Aδ in the Y-axis direction. The fifth body side connection portion 26Cε and the fifth extending side connection portion 26Dε of the fifth gate line 26ε are disposed closer to the fourth upper layer electrode 17Bδ side edge of the fifth upper layer electrode 17Bε with respect to the Y-axis direction. One side edges of the fifth body side connection portion 26Cε and the fifth extending side connection portion 26Dε with respect to the Y-axis direction are aligned with one side edge of the fifth lower layer electrode 17Aε in the Y-axis direction.

As illustrated in FIG. 5, in this embodiment, the first distance D1 is longer than the third distance D3. The first distance D1 is longer than the second distance D2 and the fourth distance D4. The third distance D3 is shorter than the second distance D2 and the fourth distance D4. The result value obtained by dividing the total of the first distance D1 and the third distance D3 by two is about same as the interval between the pixel electrodes 25 with respect to the Y-axis direction in the display area AA (refer to FIG. 3).

According to such a configuration, the straight-line distance between the first body side connection portion 26Cα, which is disposed closer to the edge of the first upper layer electrode 17Bα opposite from the second upper layer electrode 17Bβ side edge with respect to the Y-axis direction, and the first crossing portion CP1 can be increased as much as possible. The straight-line distance between the second body side connection portion 26Cβ, which is disposed closer to the edge of the second upper layer electrode 17Bβ opposite from the first upper layer electrode 17Bα side edge with respect to the Y-axis direction, and the second crossing portion CP2 can be increased as much as possible. The straight-line distance between the third body side connection portion 26Cγ, which is disposed closer to the second upper layer electrode 17Bβ side edge of the third upper layer electrode 17Bγ with respect to the Y-axis direction, and the third crossing portion CP3 can be increased as much as possible. The straight-line distance between the fourth body side connection portion 26Cδ, which is disposed closer to the edge of the fourth upper layer electrode 17Bδ opposite from the third upper layer electrode 17Bγ side edge with respect to the Y-axis direction, and the fourth crossing portion CP4 can be increased as much as possible. The straight-line distance between the fifth body side connection portion 26Cε, which is disposed closer to the fourth upper layer electrode 17Bδ side edge of the fifth upper layer electrode 17Bε with respect to the Y-axis direction, and the fifth crossing portion CP5 can be increased as much as possible. Accordingly, the straight-line distances between the body side connection portions 26C and the crossing portions CP can be increased as much as possible and therefore, electrostatic discharge is less likely to occur between the body side connection portions 26C and the crossing portions CP.

As previously described, the array substrate 21 (wiring substrate) of this embodiment includes the first gate line 26α (a first line), the first lower layer electrode 17Aα (the first conductive portion) that crosses a portion of the first gate line 26α, the second gate line 26β (a second line) that is disposed to be spaced from the first gate line 26α with respect to a first direction, and the second lower layer electrode 17Aβ (the second conductive portion) that crosses a portion of the second gate line 26β. The first gate line 26α includes the first gate body portion 26Aα (the first line portion), which is a portion of the first metal film (the first conductive film), and the first gate extending portion 26Bα (the second line portion), which is a portion of the second metal film (the second conductive film). The gate insulating film 29 (the first insulating film) is between the first metal film and the second metal film. The first gate body portion 26Aα includes the first body side connection portion 26Cα (the first end portion). The first gate extending portion 26Bα includes the first extending side connection portion 26Dα (the second end portion) that is connected to the first body side connection portion 26Cα. The first lower layer electrode 17Aα is a portion of the first metal film. The first lower layer electrode 17Aα crosses the first gate extending portion 26Bα of the first gate line 26α at the first crossing portion CP1. The second gate line 26β includes the second gate body portion 26Aβ (the third line portion), which is a portion of the first metal film, and the second gate extending portion 26Bβ (the fourth line portion), which is a portion of the second metal film. The second gate body portion 26Aβ includes the second body side connection portion 26Cβ (the third end portion) that is away from the first body side connection portion 26Cα in the first direction with having the first distance D1 therebetween. The second gate extending portion 26Bβ includes the second extending side connection portion 26Dβ (the fourth end portion) that is connected to the second body side connection portion 26Cβ. The second lower layer electrode 17Aβ is a portion of the first metal film. The second lower layer electrode 17Aβ crosses the second gate extending portion 26Bβ of the second gate line 26β at the second crossing portion CP2. The second gate extending portion 26Bβ includes the second crossing portion CP2 that is away from the first crossing portion CP1 in the first direction with having the second distance D2 therebetween. The second distance D2 differs from the first distance D1.

If the first gate body portion 26Aα and the second gate body portion 26Aβ, which are portions of the first metal film, are charged, electrostatic discharge may occur between the first body side connection portion 26Cα and the first crossing portion CP1 where the first gate extending portion 26Bα (a portion of the second metal) and the first lower layer electrode 17Aα cross, and electrostatic discharge may occur between the second body side connection portion 26Cβ and the second crossing portion CP2 where the second gate extending portion 26Bβ (a portion of the second metal) and the second lower layer electrode 17Aβ cross. In this respect, the second distance D2 between the first crossing portion CP1 and the second crossing portion CP2 with respect to the first direction differs from the first distance D1 between the first body side connection portion 26Cα and the second body side connection portion 26Cβ. According to such a configuration, the straight-line distance between the first body side connection portion 26Cα and the first crossing portion CP1 and the straight-line distance between the second body side connection portion 26Cβ and the second crossing portion CP2 can be longer compared to the configuration in which the first distance D1 and the second distance D2 are same. According to such a configuration, even if the first gate body portion 26Aα and the second gate body portion 26Aβ, which are portions of the first metal film, are charged, electrostatic discharge is less likely to occur between the first body side connection portion 26Cα and the first crossing portion CP1 and electrostatic discharge is less likely to occur between the second body side connection portion 26Cβ and the second crossing portion CP2. Since electrostatic breakdown is less likely to occur in the first crossing portion CP1 and the second crossing portion CP2 due to the electrostatic discharge, short circuit is less likely to be caused between the first gate extending portion 26Bα and the first lower layer electrode 17Aα and short circuit is less likely to be caused between the second gate extending portion 26Bβ and the second lower layer electrode 17Aβ.

The array substrate 21 of this embodiment further includes the third gate line 26γ (a third line) that is spaced from the second gate line 26β to be away from the first gate line 26α in the first direction, and the third lower layer electrode 17Aγ (the third conductive portion) that crosses a portion of the third gate line 26γ. The third gate line 26γ includes the third gate body portion 26Aγ (the fifth line portion), which is a portion of the first metal film, and the third gate extending portion 26Bγ (the sixth line portion), which is a portion of the second metal film. The third gate body portion 26Aγ includes the third body side connection portion 26Cγ (the fifth end portion) that is away from the second body side connection portion 26Cβ in the first direction with having the third distance D3 therebetween. The third gate extending portion 26Bγ includes the third extending side connection portion 26Dγ (the sixth end portion) that is connected to the third body side connection portion 26Cγ. The third lower layer electrode 17Aγ is a portion of the first metal film. The third lower layer electrode 17Aγ crosses the third gate extending portion 26Bγ of the third gate line 26γ at the third crossing portion CP3. The third gate extending portion 26Bγ includes the third crossing portion CP3 that is away from the second crossing portion CP2 in the first direction with having the fourth distance D4 therebetween. The fourth distance D4 differs from the third distance D3.

As previously described, the fourth distance D4 between the second crossing portion CP2 and the third crossing portion CP3 with respect to the first direction differs from the third distance D3 between the second body side connection portion 26Cβ and the third body side connection portion 26Cγ with respect to the first direction. With such a configuration, the straight-line distance between the third body side connection portion 26Cγ and the third crossing portion CP3 can be longer compared to the configuration in which the third distance D3 and the fourth distance D4 are same. Accordingly, even if the third gate body portion 26Aγ, which is a portion of the first metal film, is charged, electrostatic discharge is less likely to occur between the third body side connection portion 26Cγ and the third crossing portion CP3. Since electrostatic breakdown is less likely to occur in the third crossing portion CP3 due to the electrostatic discharge, short circuit is less likely to be caused between the third gate extending portion 26Bγ and the third lower layer electrode 17Aγ.

The first gate line 26α, the second gate line 26β, and the third gate line 26γ are arranged such that the second distance D2 is equal to the fourth distance D4 and the first distance D1 differs from the third distance D3. Accordingly, the position relation of the first lower layer electrode 17Aα and the first gate extending portion 26Bα with respect to the first direction, the position relation of the second lower layer electrode 17Aβ and the second gate extending portion 26Bβ with respect to the first direction, and the position relation of the third lower layer electrode 17Aγ and the third gate extending portion 26Bγ with respect to the first direction have a same pattern.

The array substrate 21 of this embodiment further includes the first upper layer electrode 17Bα (the fourth conductive portion) that is a portion of the second metal film and continuous to the first gate extending portion 26Bα, the second upper layer electrode 17Bβ (the fifth conductive portion) that is a portion of the second metal film and continuous to the second gate extending portion 26Bβ and spaced from the first upper layer electrode 17Bα in the first direction, and the third upper layer electrode 17Bγ (the sixth conductive portion that is a portion of the second metal film and continuous to the third gate extending portion 26Bγ and spaced from the second upper layer electrode 17Bβ to be away from the first upper layer electrode 17Bα in the first direction. The first body side connection portion 26Cα and the first extending side connection portion 26Dα of the first gate line 26α are disposed locally in an area corresponding to the first upper layer electrode 17Bα to be away from the second upper layer electrode 17Bβ with respect to the first direction. The second body side connection portion 26Cβ and the second extending side connection portion 26Dβ of the second gate line 26β are disposed locally in an area corresponding to the second upper layer electrode 17Bβ to be away from the first upper layer electrode 17Bα with respect to the first direction. The third body side connection portion 26Cγ and the third extending side connection portion 26Dγ of the third gate line 26γ are disposed locally in an area corresponding to the third upper layer electrode 17Bγ to be close to the second upper layer electrode 17Bβ with respect to the first direction. The straight-line distance between the first body side connection portion 26Cα, which is disposed locally in an area corresponding to the first upper layer electrode 17Bα to be away from the second upper layer electrode 17Bβ with respect to the first direction, and the first crossing portion CP1 can be increased as much as possible. The straight-line distance between the second body side connection portion 26Cβ, which is disposed locally in an area corresponding to the second upper layer electrode 17Bβ to be away from the first upper layer electrode 17Bα with respect to the first direction, and the second crossing portion CP2 can be increased as much as possible. The straight-line distance between the third body side connection portion 26Cγ, which is disposed locally in an area corresponding to the third upper layer electrode 17Bγ to be close to the second upper layer electrode 17Bβ with respect to the first direction, and the third crossing portion CP3 can be increased as much as possible.

The array substrate 21 of this embodiment further includes the shift resistor circuit 16 that includes the first unit circuit 16Uα connected to the first gate extending portion 26Bα and the second unit circuit 16Uβ connected to the second gate extending portion 26Bβ. The first unit circuit 16Uα includes the first lower layer electrode 17Aα and the second unit circuit 16Uβ includes the second lower layer electrode 17Aβ. The first lower layer electrode 17Aα and the second lower layer electrode 17Aβ are arranged at an interval in the first direction. The area of the first lower layer electrode 17Aα of the first unit circuit 16Uα is smaller than that of the first gate body portion 26Aα of the first gate line 26α. The area of the second lower layer electrode 17Aβ of the second unit circuit 16Uβ is smaller than that of the second gate body portion 26Aβ of the second gate line 26β. Therefore, if the first gate body portion 26Aα and the second gate body portion 26Aβ, which are portions of the first metal film, are charged, electrostatic discharge may occur between the first body side connection portion 26Cα and the first crossing portion CP1 and between the second body side connection portion 26Cβ and the second crossing portion CP2. However, in this embodiment, with a long straight-line distance being provided between the first body side connection portion 26Cα and the first crossing portion CP1 and between the second body side connection portion 26Cβ and the second crossing portion CP2, the above electrostatic discharge is less likely to occur.

The liquid crystal panel 11 (the display device) of this embodiment includes the array substrate 21 and the opposed substrate 20 that is disposed opposite the array substrate 21 and spaced from the array substrate 21. According to the liquid crystal panel 11 having such a configuration, short circuit is less likely to be caused in the array substrate 21 and therefore, display errors due to short circuit are less likely to be caused.

### Second Embodiment

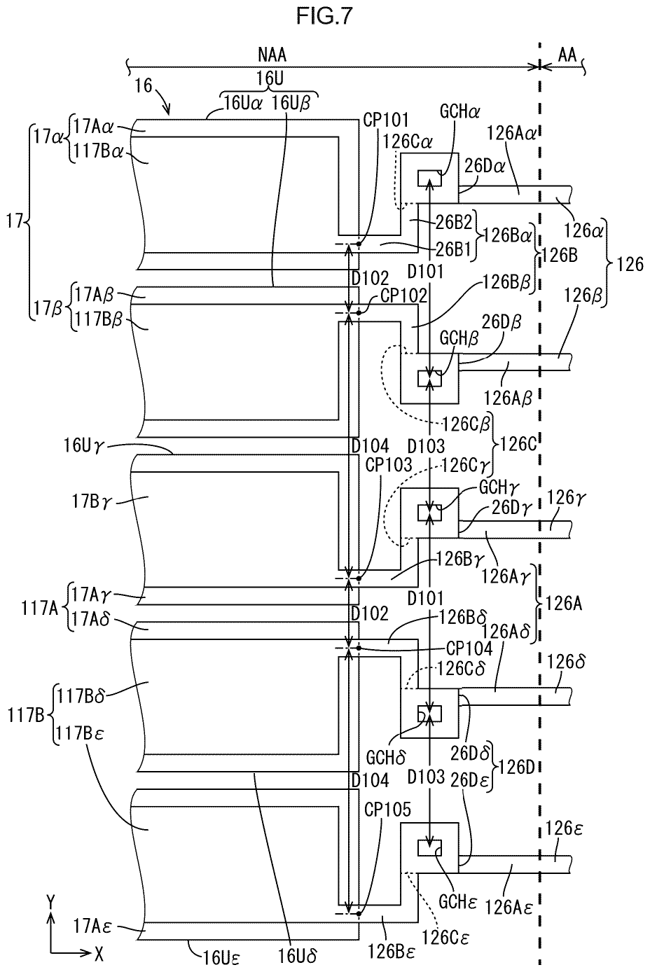

A second embodiment will be described with reference to FIG. 7. The second embodiment differs from the first embodiment in a configuration of a gate line 126. Configuration, operations, and effects similar to those of the first embodiment may not be described.

As illustrated in FIG. 7, a first gate line 126α, a second gate line 126β, a third gate line 126γ, a fourth gate line 126δ, and a fifth gate line 126ε are arranged such that a first distance D101 is equal to a third distance D103. Specifically, the position of a body side connection portion 126C and an extending side connection portion 126D of each of all the gate lines 126 with respect to the Y-axis direction substantially matches a middle position of a lower layer electrode 117A with respect to the Y-axis direction. Therefore, the body side connection portions 126C and the extending side connection portions 126D are arranged at equal intervals in the Y-axis direction. Namely, the first distance D101 and the third distance D103 that are between every two body side connection portions 126C and corresponding two extending side connection portions 126D are same. According to such a configuration, a first gate body portion 126Aα, a second gate body portion 126Aβ, a third gate body portion 126Aγ, a fourth gate body portion 126Aδ, and a fifth gate body portion 126Aε are arranged at equal intervals.

On the other hand, as illustrated in FIG. 7, the first gate line 126α, the second gate line 126β, the third gate line 126γ, the fourth gate line 126δ, and the fifth gate line 126ε are arranged such that a second distance D102 and a fourth distance D104 differ from each other. Specifically, two gate lines 126 that are adjacent to each other in the Y-axis direction are disposed such that one of the crossing portions CP of the gate extending portions 126B and the lower layer electrode 117A is on one side (an upper side in FIG. 7) and the other one of the crossing portions CP is on the other side (a lower side in FIG. 7) in the Y-axis direction with respect to the body side connection portions 126C and the extending side connection portions 126D, respectively (a middle portion of the lower layer electrode 117A in the Y-axis direction). The gate extending portion 126B is continuous to one of two corner portions of an upper layer electrode 117B that are close to the body side connection potion 126C and the extending side connection portion 126D (the right side in FIG. 7) with respect to the X-axis direction. More specifically, the first gate line 126α is disposed such that a first crossing portion CP101 is closer to a second upper layer electrode 117Bβ side edge of a first upper layer electrode 117Bα in the Y-axis direction. Other side edge (a lower side edge in FIG. 7) of the first gate extending portion 126Bα with respect to the Y-axis direction is aligned with other side edge of the first upper layer electrode 117Bα in the Y-axis direction. The second gate line 126β is disposed such that a second crossing portion CP102 is closer to the first upper layer electrode 117Bα side edge of the second upper layer electrode 117Bβ in the Y-axis direction. One side edge (an upper side edge in FIG. 7) of the second gate extending portion 126Bβ with respect to the Y-axis direction is aligned with one side edge of the second upper layer electrode 117Bβ in the Y-axis direction.

As illustrated in FIG. 7, the third gate line 126γ is disposed such that a third crossing portion CP103 is closer to the edge of the third upper layer electrode 117Bγ opposite from the second upper layer electrode 117Bβ side edge with respect to the Y-axis direction. Other side edge of the third gate extending portion 126Bγ with respect to the Y-axis direction is aligned with other side edge of the third upper layer electrode 117Bγ in the Y-axis direction. The fourth gate line 126δ is disposed such that a fourth crossing portion CP104 is closer to the third upper layer electrode 117Bγ side edge of the fourth upper layer electrode 117Bδ in the Y-axis direction. One side edge of the fourth gate extending portion 126Bδ with respect to the Y-axis direction is aligned with one side edge of the fourth upper layer electrode 117Bδ in the Y-axis direction. The fifth gate line 126ε is disposed such that a fifth crossing portion CP105 is closer to the edge of the fifth upper layer electrode 117Bε opposite from the fourth upper layer electrode 117Bδ side edge with respect to the Y-axis direction. Other side edge of the fifth gate extending portion 126Bε with respect to the Y-axis direction is aligned with other side edge of the fifth upper layer electrode 117Bε in the Y-axis direction.

In this embodiment, as illustrated in FIG. 7, the fourth distance D104 is longer than the second distance D102. The fourth distance D104 is longer than the first distance D101 and the third distance D103. The second distance D102 is shorter than the first distance D101 and the third distance D103. Each of the first distance D101 and the third distance D103 is same as the interval between the pixel electrodes 25 in the display area AA with respect to the Y-axis direction (refer to FIG. 3).

With such a configuration, the straight-line distance between the first body side connection portion 126Cα and the first crossing portion CP101, which is disposed closer to the second upper layer electrode 117Bβ side edge of the first upper layer electrode 117Bα with respect to the Y-axis direction, can be increased as much as possible. The straight-line distance between the second body side connection portion 126Cβ and the second crossing portion CP102, which is disposed closer to the first upper layer electrode 117Bα side edge of the second upper layer electrode 117Bβ with respect to the Y-axis direction can be increased as much as possible. The straight-line distance between the third body side connection portion 126Cγ and the third crossing portion CP103, which is disposed closer to the edge of the third upper layer electrode 117Bγ opposite from the second upper layer electrode 117Bβ side edge with respect to the Y-axis direction, can be increased as much as possible. The straight-line distance between the fourth body side connection portion 126Cδ and the fourth crossing portion CP104, which is disposed closer to the third upper layer electrode 117Bγ side edge of the fourth upper layer electrode 117Bδ with respect to the Y-axis direction, can be increased as much as possible. The straight-line distance between the fifth body side connection portion 126Cε and the fifth crossing portion CP105, which is disposed closer to the edge of the fifth upper layer electrode 117Bε opposite from the fourth upper layer electrode 117Bδ side edge with respect to the Y-axis direction, can be increased as much as possible. Accordingly, the straight-line distances between the body side connection portions 126C and the crossing portions CP can be increased as much as possible and therefore, electrostatic discharge is less likely to occur between the body side connection portions 126C and the crossing portions CP.

As previously described, according to this embodiment, the first gate line 126α, the second gate line 126β, and the third gate line 126γ are arranged such that the second distance D102 and the fourth distance D104 differ from each other and the first distance D101 and the third distance D103 are same. Accordingly, the first gate body portion 126Aα, the second gate body portion 126Aβ, and the third gate body portion 126Aγ are arranged at equal intervals.

An array substrate of this embodiment further includes the first upper layer electrode 117Bα that is a portion of the second metal film and continuous to the first gate extending portion 126Bα, the second upper layer electrode 117Bβ that is a portion of the second metal film and continuous to the second gate extending portion 126Bβ and spaced from the first upper layer electrode 117Bα in the first direction, and the third upper layer electrode 117Bγ that is a portion of the second metal film and continuous to the third gate extending portion 126Bγ and spaced from the second upper layer electrode 117Bβ to be away from the first upper layer electrode 117Bα in the first direction. The first gate line 126α is disposed such that the first crossing portion CP101 is disposed locally in an area corresponding to the first upper layer electrode 117Bα to be closer to the second upper layer electrode 117Bβ with respect to the first direction. The second gate line 126β is disposed such that the second crossing portion CP102 is disposed locally in an area corresponding to the second upper layer electrode 117Bβ to be closer to the first upper layer electrode 117Bα with respect to the first direction. The third gate line 126γ is disposed such that the third crossing portion CP103 is disposed locally in an area corresponding to the third upper layer electrode 117Bγ to be away from the second upper layer electrode 117Bβ with respect to the first direction. The straight-line distance between the first body side connection portion 126Cα and the first crossing portion CP101, which is disposed locally in an area corresponding to the first upper layer electrode 117Bα to be closer to the second upper layer electrode 117Bβ with respect to the first direction, can be increased as much as possible. The straight-line distance between the second body side connection portion 126Cβ and the second crossing portion CP102, which is disposed locally in an area corresponding to the second upper layer electrode 117Bβ to be closer to the first upper layer electrode 117Bα with respect to the first direction, can be increased as much as possible. The straight-line distance between the third body side connection portion 126Cγ and the third crossing portion CP103, which is disposed locally in an area corresponding to the third upper layer electrode 117Bγ to be away from the second upper layer electrode 117Bβ with respect to the first direction, can be increased as much as possible.

### Third Embodiment

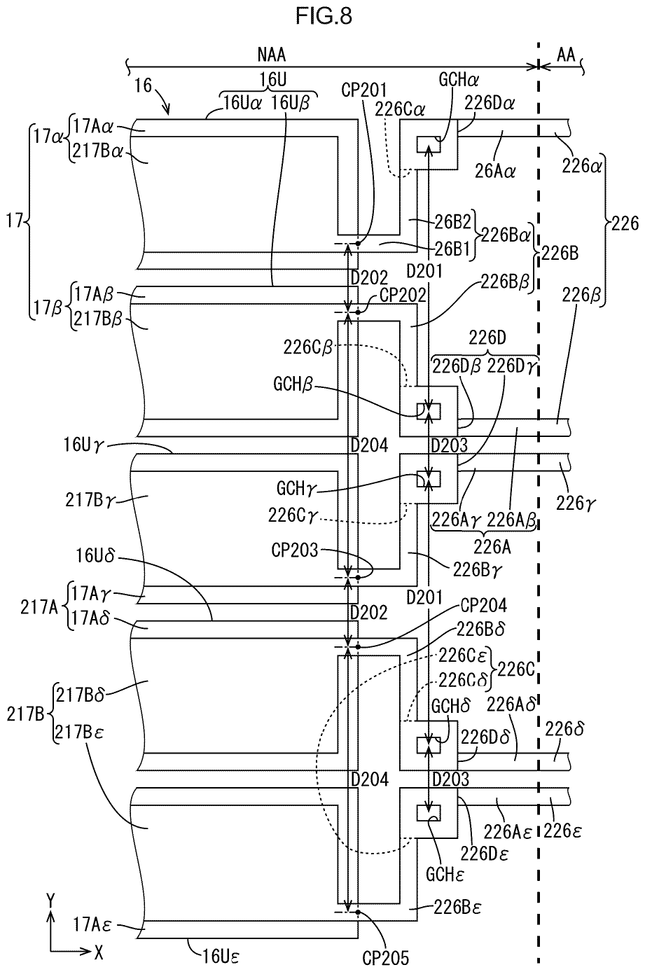

A third embodiment will be described with reference to FIG. 8. The third embodiment differs from the first and second embodiments in a configuration of a gate line 226. Configuration, operations, and effects similar to those of the first and second embodiments may not be described.

As illustrated in FIG. 8, a first gate line 226α, a second gate line 226β, a third gate line 226γ, a fourth gate line 226δ, and a fifth gate line 226ε are arranged such that a first distance D201 and a third distance D203 differ from each other similar to the first embodiment and a second distance D202 and a fourth distance D204 differ from each other similar to the second embodiment. Specifically, similar to the first embodiment, two gate lines 226 that are adjacent to each other in the Y-axis direction are disposed such that a body side connection portion 226C and an extending side connection portion 226D of one of the two gate lines 226 is on one side (an upper side in FIG. 8) and those of the other one of the two gate lines 226 is on the other side (a lower side in FIG. 7) in the Y-axis direction with respect to the middle portion of a lower layer electrode 217A in the Y-axis direction. Furthermore, similar to the second embodiment, the two gate lines 226 that are adjacent to each other in the Y-axis direction are disposed such that the crossing portion CP of the gate extending portions 226B of one of the two gate lines 226 and the lower layer electrode 217A is on one side (an upper side in FIG. 8) and the crossing portions CP of the gate extending portions 226B of other one of the two gate lines 226 and the lower layer electrode 217A is on the other side (a lower side in FIG. 8) in the Y-axis direction with respect to the middle portion of the lower layer electrode 217A in the Y-axis direction. The arrangement of the gate lines 226α-226ε is similar to that of the first and second embodiments.

In this embodiment, as illustrated in FIG. 8, the first distance D201 is same as the first distance D1 of the first embodiment, and the third distance D203 is same as the third distance D3 of the first embodiment (refer to FIG. 5). Furthermore, in this embodiment, the second distance D202 is same as the second distance D102 of the second embodiment and the fourth distance D204 is same as the fourth distance D104 of the second embodiment (refer to FIG. 7). A difference between the first distance D201 and the third distance D203 is greater than a difference between the first distance D1 and the third distance D3 of the first embodiment and is greater than a difference between the first distance D101 and the third distance D103 of the second embodiment. Furthermore, a difference between the second distance D202 and the fourth distance D204 is greater than a difference between the second distance D2 and the fourth distance D4 of the first embodiment and is greater than a difference between the second distance D102 and the fourth distance D104 of the second embodiment.

With such a configuration, the straight-line distance between the first body side connection portion 226Cα, which is disposed closer to the edge of the first upper layer electrode 217Bα opposite from the second upper layer electrode 217Bβ side edge with respect to the Y-axis direction, and the first crossing portion CP201, which is disposed closer to the second upper layer electrode 217Bβ side edge of the first upper layer electrode 217Bα with respect to the Y-axis direction, can be maximized. The straight-line distance between the second body side connection portion 226Cβ, which is disposed closer to the third upper layer electrode 217Bγ side edge of the second upper layer electrode 217Bβ with respect to the Y-axis direction, and the second crossing portion CP202, which is disposed closer to the first upper layer electrode 217Bα side edge of the second upper layer electrode 217Bα with respect to the Y-axis direction, can be maximized. The straight-line distance between the third body side connection portion 226Cγ, which is disposed closer to the second upper layer electrode 217Bβ side edge of the third upper layer electrode 217Bγ with respect to the Y-axis direction, and the third crossing portion CP203, which is disposed closer to the edge of the third upper layer electrode 217Bγ opposite from the second upper layer electrode 217Bα side edge with respect to the Y-axis direction, can be maximized. The straight-line distance between the fourth body side connection portion 226Cδ, which is disposed closer to the fifth upper layer electrode 217Bε side edge of the fourth upper layer electrode 217Bδ with respect to the Y-axis direction, and the fourth crossing portion CP204, which is disposed closer to the third upper layer electrode 217Bγ side edge of the fourth upper layer electrode 217Bδ with respect to the Y-axis direction, can be maximized. The straight-line distance between the fifth body side connection portion 226Cε, which is disposed closer to the fourth upper layer electrode 217Bδ side edge of the fifth upper layer electrode 217Bε with respect to the Y-axis direction, and the fifth crossing portion CP205, which is disposed closer to the edge of the fifth upper layer electrode 217Bε opposite from the fourth upper layer electrode 217Bδ side edge with respect to the Y-axis direction, can be maximized. Thus, with the straight-line distance between the body side connection portion 226C and the crossing portion CP being maximized, electrostatic discharge is further less likely to occur between the body side connection portion 226C and the crossing portion CP.

As previously described, according to this embodiment, the first gate line 226α, the second gate line 226β, and the third gate line 226γ are disposed such that the first distance D201 and the third distance D203 differ from each other and the second distance D202 and the fourth distance D204 differ from each other. With such a configuration, the straight-line distance between the first body side connection portion 226Cα and the first crossing portion CP201, the straight-line distance between the second body side connection portion 226Cβ and the second crossing portion CP202, and the straight-line distance between the third body side connection portion 226Cγ and the third crossing portion CP203 are appropriately maximized.

The array substrate of this embodiment further includes the first upper layer electrode 217Bα that is a portion of the second metal film and continuous to the first gate extending portion 226Bα, the second upper layer electrode 217Bβ that is a portion of the second metal film and continuous to the second gate extending portion 226Bβ and spaced from the first upper layer electrode 217Bα in the first direction, and the third upper layer electrode 217Bγ that is a portion of the second metal film and continuous to the third gate extending portion 226Bγ and spaced from the second upper layer electrode 217Bβ to be away from the first upper layer electrode 217Bα in the first direction. The first gate line 226α is disposed such that the first body side connection portion 226Cα and the first extending side connection portion 226Dα are disposed locally in an area corresponding to the first upper layer electrode 217Bα to be away from the second upper layer electrode 217Bβ with respect to the first direction and the first crossing portion CP201 is disposed locally in an area corresponding to the first upper layer electrode 217Bα to be closer to the second upper layer electrode 217Bβ with respect to the first direction. The second gate line 226β is disposed such that the second body side connection portion 226Cβ and the second extending side connection portion 226Dβ are disposed locally in an area corresponding to the second upper layer electrode 217Bβ to be away from the first upper layer electrode 217Bα with respect to the first direction and the second crossing portion CP202 is disposed locally in an area corresponding to the second upper layer electrode 217Bβ to be closer to the first upper layer electrode 217Bα with respect to the first direction. The third gate line 226γ is disposed such that the third body side connection portion 226Cγ and the third extending side connection portion 226Dγ are disposed locally in an area corresponding to the third upper layer electrode 217Bγ to be closer to the second upper layer electrode 217Bβ with respect to the first direction and the third crossing portion CP303 is disposed locally in an area corresponding to the third upper layer electrode 217Bγ to be away from the second upper layer electrode 217Bβ with respect to the first direction. The straight-line distance between the first body side connection portion 226Cα, which is disposed locally in an area corresponding to the first upper layer electrode 217Bα to be away from the second upper layer electrode 217Bβ with respect to the first direction, and the first crossing portion CP201, which is disposed locally in an area corresponding to the first upper layer electrode 217Bα to be closer to the second upper layer electrode 217Bβ with respect to the first direction, can be maximized. The straight-line distance between the second body side connection portion 226Cβ, which is disposed locally in an area corresponding to the second upper layer electrode 217Bβ to be away from the first upper layer electrode 217Bα with respect to the first direction, and the second crossing portion CP202, which is disposed locally in an area corresponding to the second upper layer electrode 217Bβ to be closer to the first upper layer electrode 217Bα with respect to the first direction, can be maximized. The straight-line distance between the third body side connection portion 226Cγ, which is disposed locally in an area corresponding to the third upper layer electrode 217Bγ to be closer to the second upper layer electrode 217Bβ with respect to the first direction, and the third crossing portion CP203, which is disposed locally in an area corresponding to the third upper layer electrode 217Bγ to be away from the second upper layer electrode 217Bβ with respect to the first direction, can be maximized.

### Fourth Embodiment

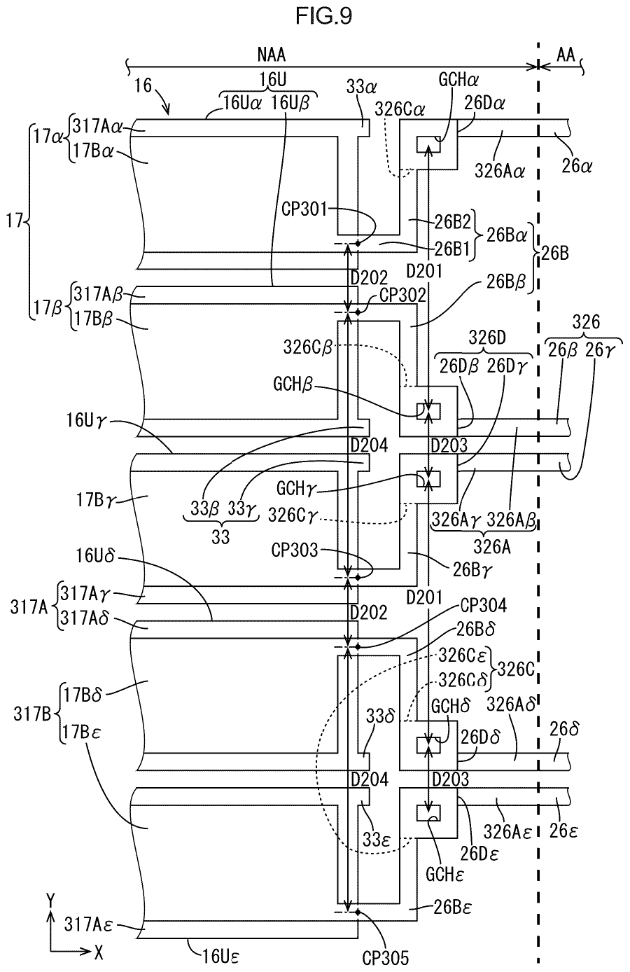

A fourth embodiment will be described with reference to FIG. 9. The fourth embodiment differs from the third embodiment in a configuration of a gate line 326. Configuration, operations, and effects similar to those of the first embodiment may not be described.

As illustrated in FIG. 9, a lower layer electrode 317A of this embodiment includes a projection portion 33 in a portion thereof closer to a body side connection portion 326C than the crossing portion CP is. The projection portion 33 projects from the portion of the lower layer electrode 317A toward the body side connection portion 326C (rightward in FIG. 9) with respect to the X-axis direction. The projection portion 33 is a portion of the first metal film and directly continuous to the lower layer electrode 317A. The projection portion 33 does not overlap an upper layer electrode 317B. The projection portion 33 is continuous to one of two corner portions of the lower layer electrode 317A that are close to the body side connection potion 326C and an extending side connection portion 326D with respect to the X-axis direction. A gate extending portion 326B is continuous to one of two corner portions of the upper layer electrode 317B that are close to the body side connection potion 326C and the extending side connection portion 326D with respect to the X-axis direction. The projection portion 33 is continuous to one of the corner portions of the lower layer electrode 317A that is farther away from the gate extending portion 326B in the Y-axis direction. The projection portion 33 is spaced from the body side connection portion 326C and the extending side connection portion 326D in the X-axis direction.

Hereinafter, one of the projection portions 33 included in the first lower layer electrode 317Aα is defined as a first projection portion 33α, one of the projection portions 33 included in a second lower layer electrode 317Aβ is defined as a second projection portion 33β, one of the projection portions 33 included in a third lower layer electrode 317Aγ is defined as a third projection portion 33γ, one of the projection portions 33 included in a fourth lower layer electrode 317Aδ is defined as a fourth projection portion 33δ, and one of the projection portions 33 included in a fifth lower layer electrode 317Aε is defined as a fifth projection portion 33ε.

As illustrated in FIG. 9, the first projection portion 33α is at a corner portion of the first lower layer electrode 317Aα closer to the first body side connection portion 326Cα than a first crossing portion CP301 is and projects toward the first body side connection portion 326Cα in the X-axis direction. The second projection portion 33β is at a corner portion of the second lower layer electrode 317Aβ closer to the second body side connection portion 326Cβ than a second crossing portion CP302 is and projects toward the second body side connection portion 326Cβ in the X-axis direction. The third projection portion 33γ is at a corner portion of the third lower layer electrode 317Aγ closer to the third body side connection portion 326Cγ than a third crossing portion CP303 is and projects toward the third body side connection portion 326Cγ in the X-axis direction. The fourth projection portion 33δ is at a corner portion of the fourth lower layer electrode 317Aδ closer to the fourth body side connection portion 326Cδ than a fourth crossing portion CP304 is and projects toward the fourth body side connection portion 326Cδ in the X-axis direction. The fifth projection portion 33ε is at a corner portion of the fifth lower layer electrode 317Aε closer to the fifth body side connection portion 326Cε than a fifth crossing portion CP305 is and projects toward the fifth body side connection portion 326Cε in the X-axis direction.

Thus, the first projection portion 33α of the first lower layer electrode 317Aα is closer to the first body side connection portion 326Cα than the first crossing portion CP301 is. Therefore, if the first gate body portion 326Aα, which is a portion of the first metal film, is charged, electrostatic discharge first occurs between the first body side connection portion 326Cα and the first projection portion 33α. Accordingly, electrostatic breakdown is less likely to occur in the first crossing portion CP301. The second projection portion 33β of the second lower layer electrode 317Aβ is closer to the second body side connection portion 326Cβ than the second crossing portion CP302 is. Therefore, if the second gate body portion 326Aβ, which is a portion of the first metal film, is charged, electrostatic discharge first occurs between the second body side connection portion 326Cβ and the second projection portion 33β. Accordingly, electrostatic breakdown is less likely to occur in the second crossing portion CP302. The third projection portion 33γ of the third lower layer electrode 317Aγ is closer to the third body side connection portion 326Cγ than the third crossing portion CP303 is. Therefore, if the third gate body portion 326Aγ, which is a portion of the first metal film, is charged, electrostatic discharge first occurs between the third body side connection portion 326Cγ and the third projection portion 33γ. Accordingly, electrostatic breakdown is less likely to occur in the third crossing portion CP303. The fourth projection portion 33δ of the fourth lower layer electrode 317Aδ is closer to the fourth body side connection portion 326Cδ than the fourth crossing portion CP304 is. Therefore, if the fourth gate body portion 326Aδ, which is a portion of the first metal film, is charged, electrostatic discharge first occurs between the fourth body side connection portion 326Cδ and the fourth projection portion 33δ. Accordingly, electrostatic breakdown is less likely to occur in the fourth crossing portion CP304. The fifth projection portion 33ε of the fifth lower layer electrode 317Aε is closer to the fifth body side connection portion 326Cε than the fifth crossing portion CP305 is. Therefore, if the fifth gate body portion 326Aε, which is a portion of the first metal film, is charged, electrostatic discharge first occurs between the fifth body side connection portion 326Cε and the fifth projection portion 33ε. Accordingly, electrostatic breakdown is less likely to occur in the fifth crossing portion CP305. As previously described, since electrostatic breakdown is less likely to occur in the crossing portion CP, short circuit is less likely to be caused between the gate extending portion 326B and the lower layer electrode 317A. Even if electrostatic discharge occurs between the body side connection portion 326C and the projection portion 33, the projection portion 33 does not overlap the upper layer electrode 317B and therefore, short circuit is not caused between the lower layer electrode 317A and the upper layer electrode 317B.

As previously described, in this embodiment, the first lower layer electrode 317Aα includes the first projection portion 33α that projects toward the first body side connection portion 326Cα in the second direction that crosses the first direction. A distance between the first projection portion 33α and the first body side connection portion 326Cα is shorter than a distance between the first crossing portion CP301 and the first body side connection portion 326Cα. The second lower layer electrode 317Aβ includes the second projection portion 33β that projects toward the second body side connection portion 326Cβ in the second direction. A distance between the second projection portion 33β and the second body side connection portion 326Cβ is shorter than a distance between the second crossing portion CP302 and the second body side connection portion 326Cβ. The first projection portion 33α of the first lower layer electrode 317Aα is disposed closer to the first body side connection portion 326Cα than the first crossing portion CP301 is. Therefore, if the first gate body portion 326Aα, which is a portion of the first metal film, is charged, electrostatic discharge first occurs between the first body side connection portion 326Cα and the first projection portion 33α. Accordingly, electrostatic breakdown is less likely to occur in the first crossing portion CP301. The second projection portion 33β of the second lower layer electrode 317Aβ is disposed closer to the second body side connection portion 326Cβ than the second crossing portion CP302 is. Therefore, if the second gate body portion 326Aβ, which is a portion of the first metal film, is charged, electrostatic discharge first occurs between the second body side connection portion 326Cβ and the second projection portion 33β. Accordingly, electrostatic breakdown is less likely to occur in the second crossing portion CP302.

### Fifth Embodiment

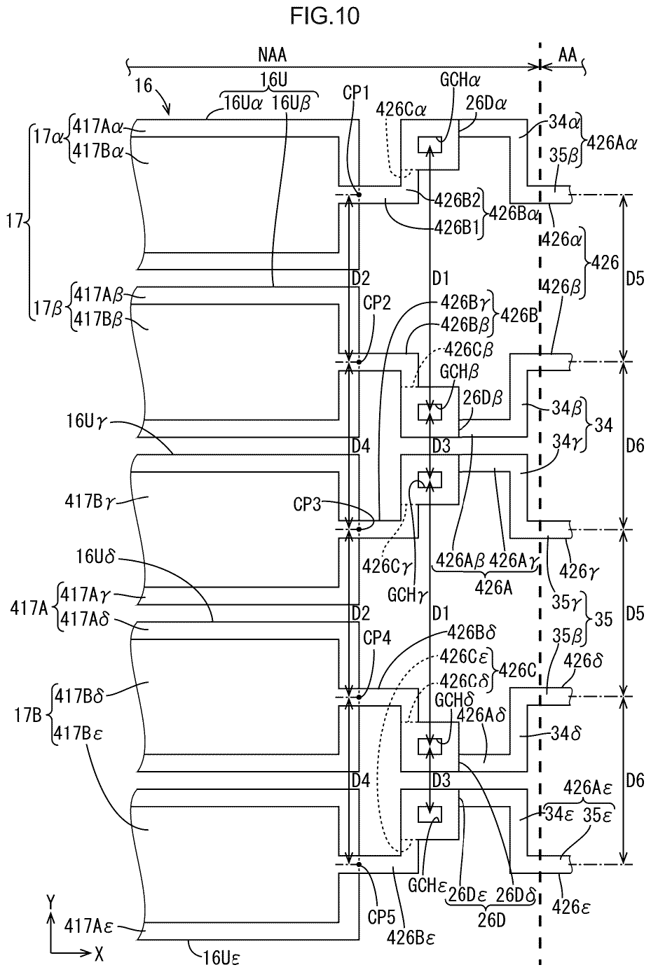

A fifth embodiment will be described with reference to FIG. 10. The fifth embodiment differs from the first embodiment in a configuration of a gate line 426. Configuration, operations, and effects similar to those of the first embodiment may not be described.

As illustrated in FIG. 10, a gate body portion 426A of this embodiment includes a bent portion 34 and an extending portion 35. The bent portion 34 is continuous to a body side connection portion 426C and has a bent plan view shape. The extending portion 35 is continuous to the bent portion 34. The bent portion 34 has a substantially L-shaped plan view shape. The bent portion 34 extends from the body side connection portion 426C along the X-axis direction toward an opposite side from a lower layer electrode 417A (rightward in FIG. 10) and is subsequently bent to extend along the Y-axis direction. The direction in which the bent portion 34 of the gate body portion 426A is bent is opposite from the direction in which an extending portion 426B2 is bent from a crossing portion 426B1 of a gate extending portion 426B. The extending portion 35 extends from an end of the bent portion 34 opposite from the body side connection portion 426C side end and along the X-axis direction toward an opposite side from the body side connection portion 426C. The extending portion 35 extending along the X-axis direction is on a same line as the crossing portion 426B1 extending along the X-axis direction. Namely, the Y-axis dimension of the bent portion 34 is adjusted such that the extending portion 35 is on the same line as the crossing portion 426B1.

Hereinafter, with respect to the bent portions 34 and the extending portions 35, a first gate body portion 426Aα includes a first bent portion 34α and a first extending portion 35α, a second gate body portion 426Aβ includes a second bent portion 34β and a second extending portion 35β, a third gate body portion 426Aγ includes a third bent portion 34γ and a third extending portion 35γ, a fourth gate body portion 426Aδ includes a fourth bent portion 34δ and a fourth extending portion 35δ, and a fifth gate body portion 426Aε includes a fifth bent portion 34ε and a fifth extending portion 35ε.

As illustrated in FIG. 10, the first bent portion 34α of the first gate body portion 426Aα extends from the first body side connection portion 426Cα along the X-axis direction toward an opposite side from a first lower layer electrode 417Aα and is subsequently bent to extend downward in FIG. 10 along the Y-axis direction. The direction in which the first bent portion 34α is bent is opposite from the direction in which the extending portion 426B2 is bent from the crossing portion 426B1 of a first gate extending portion 426Bα (upward in FIG. 10). The first extending portion 35α extends from an end of the first bent portion 34α along the X-axis direction toward an opposite side from the first body side connection portion 426Cα. The second bent portion 34β of the second gate body portion 426Aβ extends from the second body side connection portion 426Cβ along the X-axis direction toward an opposite side from a second lower layer electrode 417Aβ and is subsequently bent to extend upward in FIG. 10 along the Y-axis direction. The direction in which the second bent portion 34β is bent is opposite from the direction in which the extending portion 426B2 is bent from the crossing portion 426B1 of a second gate extending portion 426Bβ (downward in FIG. 10). The second extending portion 35β extends from an end of the second bent portion 34β along the X-axis direction toward an opposite side from the second body side connection portion 426Cβ.

As illustrated in FIG. 10, the third bent portion 34γ of the third gate body portion 426Aγ extends from the third body side connection portion 426Cγ along the X-axis direction toward an opposite side from a third lower layer electrode 417Aγ and is subsequently bent to extend downward in FIG. 10 along the Y-axis direction. The direction in which the third bent portion 34γ is bent is opposite from the direction in which the extending portion 426B2 is bent from the crossing portion 426B1 of a third gate extending portion 426Bγ (upward in FIG. 10). The fourth bent portion 34δ of the fourth gate body portion 426Aδ extends from the fourth body side connection portion 426Cδ along the X-axis direction toward an opposite side from a fourth lower layer electrode 417Aδ and is subsequently bent to extend upward in FIG. 10 along the Y-axis direction. The direction in which the fourth bent portion 34δ is bent is opposite from the direction in which the extending portion 426B2 is bent from the crossing portion 426B1 of a fourth gate extending portion 426Bδ (downward in FIG. 10). The fifth bent portion 34ε of the fifth gate body portion 426Aε extends from the fifth body side connection portion 426Cε along the X-axis direction toward an opposite side from a fifth lower layer electrode 417Aε and is subsequently bent to extend downward in FIG. 10 along the Y-axis direction. The direction in which the fifth bent portion 34ε is bent is opposite from the direction in which the extending portion 426B2 is bent from the crossing portion 426B1 of a fifth gate extending portion 426Bε (upward in FIG. 10).

As illustrated in FIG. 10, the first gate body portion 426Aα of the first gate line 426α and the second gate body portion 426Aβ of the second gate line 426β are disposed such that a fifth distance D5 is between the first extending portion 35α and the second extending portion 35β in the Y-axis direction. The second gate body portion 426Aβ of the second gate line 426β and the third gate body portion 426Aγ of the third gate line 426γ are disposed such that a sixth distance D6 is between the second extending portion 35β and the third extending portion 35γ in the Y-axis direction. The sixth distance D6 is same as the fifth distance D5. Namely, the first gate body portion 426Aα, the second gate body portion 426Aβ, and the third gate body portion 426Aγ are disposed such that the first extending portion 35α, the second extending portion 35β, and the third extending portion 35γ are arranged at equal intervals in the Y-axis direction. Each of the fifth distance D5 and the sixth distance D6 is same as the interval between the pixel electrodes 25 in the display area AA with respect to the Y-axis direction (refer to FIG. 3).

As illustrated in FIG. 10, the third gate body portion 426Aγ of the third gate line 426γ and the fourth gate body portion 426Aδ of the fourth gate line 426δ are disposed such that the fifth distance D5 is between the third extending portion 35γ and the fourth extending portion 35δ in the Y-axis direction. Namely, the position relation of the third gate line 426γ and the fourth gate line 426δ is same as the position relation of the first gate line 426α and the second gate line 426β. The fourth gate body portion 426Aδ of the fourth gate line 426δ and the fifth gate body portion 426Aε of the fifth gate line 426ε are disposed such that the sixth distance D6 is between the fourth extending portion 35δ and the fifth extending portion 35ε in the Y-axis direction. Namely, the position relation of the fourth gate line 426δ and the fifth gate line 426ε is same as the position relation of the second gate line 426β and the third gate line 426γ.

The first body side connection portion 426Cα, the second body side connection portion 426Cβ, the third body side connection portion 426Cγ, the fourth body side connection portion 426Cδ, and the fifth body side connection portion 426Cε are disposed close to edges of the first upper layer electrode 417Bα, the second upper layer electrode 417Bβ, the third upper layer electrode 417Bγ, the fourth upper layer electrode 417Bδ, and the fifth upper layer electrode 417Bε, respectively. Even with such a configuration, in this embodiment, with the first bent portion 34α, the second bent portion 34β, the third bent portion 34γ, the fourth bent portion 34δ, and the fifth bent portion 34ε, the fifth distance D5 between the first extending portion 35α and the second extending portion 35β, the sixth distance D6 between the second extending portion 35β and the third extending portion 35γ, the fifth distance D5 between the third extending portion 35γ and the fourth extending portion 35δ, and the sixth distance D6 between the fourth extending portion 35δ and the fifth extending portion 35ε are same. Accordingly, the first extending portion 35α, the second extending portion 35β, the third extending portion 35γ, the fourth extending portion 35δ, and the fifth extending portion 35ε are arranged at equal intervals.

As previously described, according to this embodiment, the first gate body portion 426Aα includes the first bent portion 34α that extends from the first body side connection portion 426Cα along the second direction crossing the first direction to be away from the first lower layer electrode 417Aα and is subsequently bent to extend along the first direction and the first extending portion 35α that extends from an end of the first bent portion 34α along the second direction to be away from the first body side connection portion 426Cα. The second gate body portion 426Aβ includes the second bent portion 34β that extends from the second body side connection portion 426Cβ along the second direction to be away from the second lower layer electrode 417Aβ and is subsequently bent to extend along the first direction and the second extending portion 35β that extends from an end of the second bent portion 34β along the second direction to be away from the second body side connection portion 426Cβ. The third gate body portion 426Aγ includes the third bent portion 34γ that extends from the third body side connection portion 426Cγ along the second direction to be away from the third lower layer electrode 417Aγ and is subsequently bent to extend along the first direction and the third extending portion 35γ that extends from an end of the third bent portion 34γ along the second direction to be away from the third body side connection portion 426Cγ. The first gate body portion 426Aα, the second gate body portion 426Aβ, and the third gate body portion 426Aγ are disposed such that the fifth distance D5 between the first extending portion 35α and the second extending portion 35β with respect to the first direction and the sixth distance D6 between the second extending portion 35β and the third extending portion 35γ with respect to the first direction are same. The first body side connection portion 426Cα, the second body side connection portion 426Cβ, and the third body side connection portion 426Cγ are disposed locally in areas corresponding to the first upper layer electrode 417Bα, the second upper layer electrode 417Bβ, and the third upper layer electrode 417Bγ, respectively, with respect to the first direction. Even with such a configuration, with the first bent portion 34α, the second bent portion 34β, and the third bent portion 34γ, the fifth distance D5 between the first extending portion 35α and the second extending portion 35β and the sixth distance D6 between the second extending portion 35β and the third extending portion 35γ are same. Accordingly, the first extending portion 35α, the second extending portion 35β, and the third extending portion 35γ are arranged at equal intervals.

### Sixth Embodiment

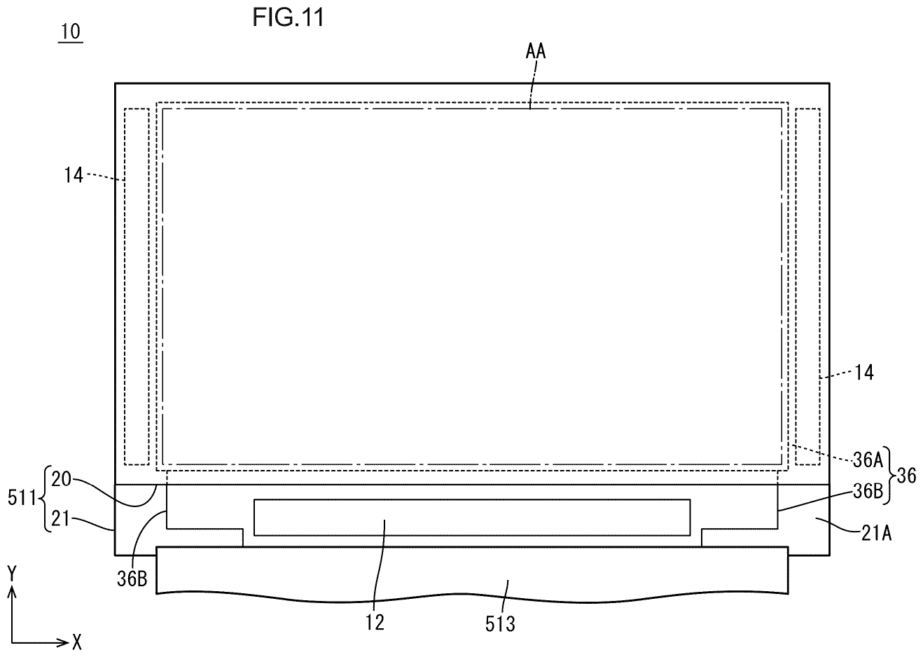

A sixth embodiment will be described with reference to FIGS. 11 to 13. The sixth embodiment includes a common main line 36 (a fourth line) in addition to the configuration of the third embodiment. Configuration, operations, and effects similar to those of the third embodiment may not be described.

As illustrated in FIG. 11, a liquid crystal panel 511 of this embodiment includes a common main line 36 in the non-display area NAA. The common main line 36 is connected to the common electrode 28 (refer to FIG. 4) and a flexible substrate 513. The common main line 36 includes a frame portion 36A and an extending portion 36B. The frame portion 36A extends around an entire display area AA. The extending portion 36B extends from the frame portion 36A to the flexible substrate 513. The frame portion 36A is connected to the common electrode 28 via a common branch line. The common main line 36 is supplied with a common potential signal from an external circuit board via the flexible substrate 513.

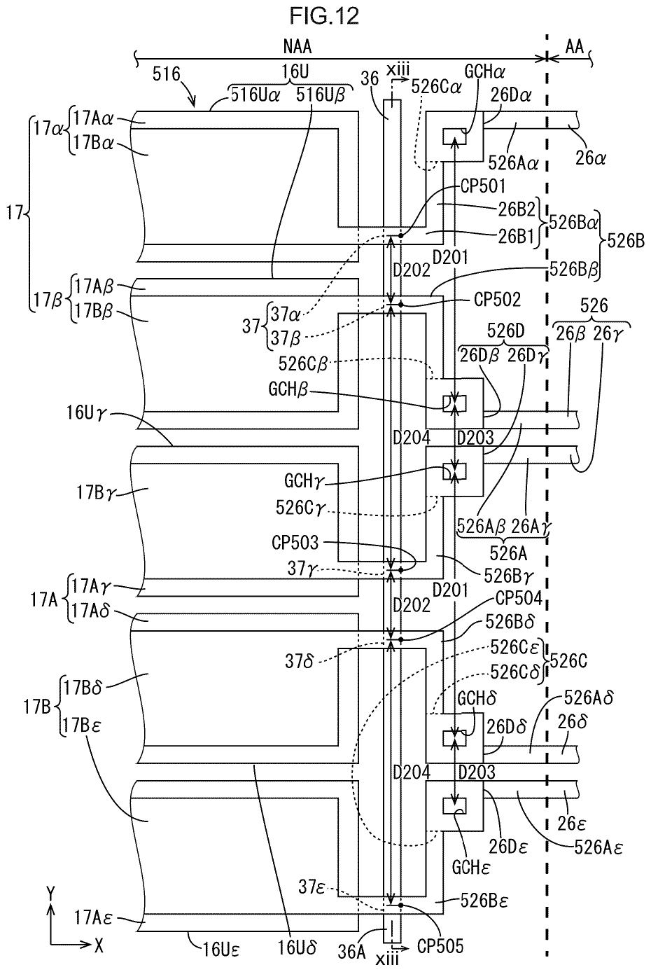

As illustrated in FIG. 12, a portion of the frame portion 36A of the common main line 36 extending along the Y-axis direction is disposed away from a shift resistor circuit 516 in the X-axis direction and on the display area AA side (a right side in FIG. 12) of the shift resistor circuit 516 with respect to the X-axis direction. The portion of the frame portion 36A extending along the Y-axis direction is disposed away from a body side connection portion 526C and an extending side connection portion 526D in the X-axis direction and on the opposite side from the display area AA (a left side in FIG. 12) with respect to the body side connection portion 526C and the extending side connection portion 526D in the X-axis direction. The portion of the frame portion 36A extending along the Y-axis direction is disposed between the shift resistor circuit 516 and the body side connection portions 526C in the X-axis direction.

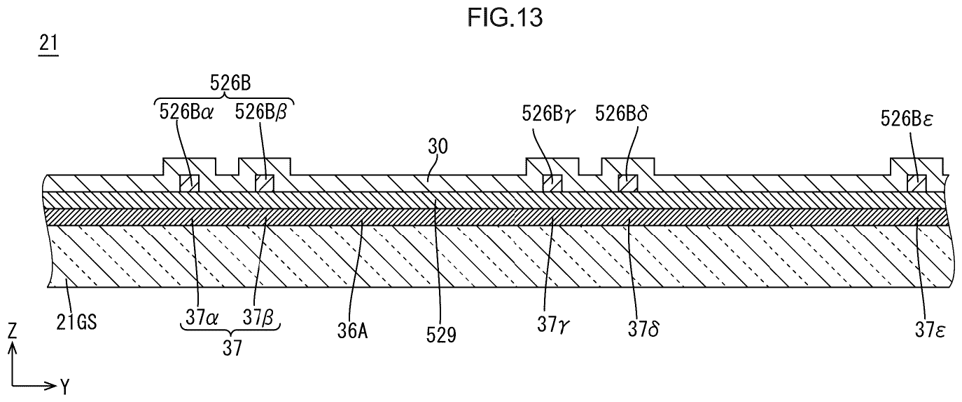

As illustrated in FIG. 13, the common main line 36 is a portion of the first metal film. As illustrated in FIGS. 12 and 13, the portion of the frame portion 36A of the common main line 36 extending along the Y-axis direction crosses gate extending portions 526B that are arranged in the Y-axis direction. Portions of the common main line 36 crossing the gate extending portions 526B are configured as conductive portions 37. A gate insulating film 529 is disposed between the conductive portions 37 and the gate extending portions 526B and insulates the conductive portions 37 from the gate extending portions 526B.

The conductive portions 37 include a first conductive portion 37α that is a portion of the common main line 36 crossing a first gate extending portion 526Bα, a second conductive portion 37β that is a portion of the common main line 36 crossing a second gate extending portion 526Bβ, a third conductive portion 37γ that is a portion of the common main line 36 crossing a third gate extending portion 526Bγ, a fourth conductive portion 37δ that is a portion of the common main line 36 crossing a fourth gate extending portion 526Bδ, and a fifth conductive portion 37ε that is a portion of the common main line 36 crossing a fifth gate extending portion 526Bε.

The common main line 36 of this embodiment is disposed closer to the body side connection portion 526C than the shift resistor circuit 516 is in the X-axis direction. Therefore, if the gate body portion 526A, which is a portion of the first metal film, is charged, electrostatic discharge may occur between the body side connection portion 526C and the crossing portion CP. In this respect, the gate lines 526 are disposed such that the adjacent gate extending portions 526B are bent in opposite directions as described in the first and third embodiments. With such a configuration, the distance between the two body side connection portions 526C that are adjacent to each other in the Y-axis direction differs from the distance between the two crossing portions CP that are adjacent to each other in the Y-axis direction. Accordingly, the straight-line distance between the first body side connection portions 526Cα and a first crossing portion CP501, the straight-line distance between the second body side connection portions 526Cβ and a second crossing portion CP502, the straight-line distance between the third body side connection portions 526Cγ and a third crossing portion CP503, the straight-line distance between the fourth body side connection portions 526Cδ and a fourth crossing portion CP504, and the straight-line distance between the fifth body side connection portions 526Cε and a fifth crossing portion CP505 can be long. Therefore, electrostatic discharge is less likely to occur.

As previously described, this embodiment includes the shift resistor circuit 516 that includes a first unit circuit 516Uα connected to the first gate extending portion 526Bα and a second unit circuit 516Uβ connected to the second gate extending portion 526Bβ, and the common main line 36 (the fourth line) that extends along the first direction between the shift resistor circuit 516 and the each of the first body side connection portion 526Cα and the second body side connection portion 526Cβ with respect to the second direction crossing the first direction. The common main line 36 is a portion of the first metal film. The first conductive portion 37α is a portion of the common main line 36 crossing the first gate extending portion 526Bα. The second conductive portion 37β is a portion of the common main line 36 crossing the second gate extending portion 526Bβ. The common main line 36 including the first conductive portion 37α and the second conductive portion 37β are closer to the first body side connection portion 526Cα and the second body side connection portion 526Cβ than the shift resistor circuit 516 is with respect to the second direction. Therefore, if the first gate body portion 526Aα and the second gate body portion 526Aβ, which are portions of the first metal, are charged, electrostatic discharge may occur between the first body side connection portion 526Cα and the first crossing portion CP501 and between the second body side connection portion 526Cβ and the second crossing portion CP502. However, the long straight-line distance can be provided between the first body side connection portion 526Cα and the first crossing portion CP501 and the long straight-line distance can be provided between the second body side connection portion 526Cβ and the second crossing portion CP502. Therefore, electrostatic discharge is less likely to occur.

### Seventh Embodiment

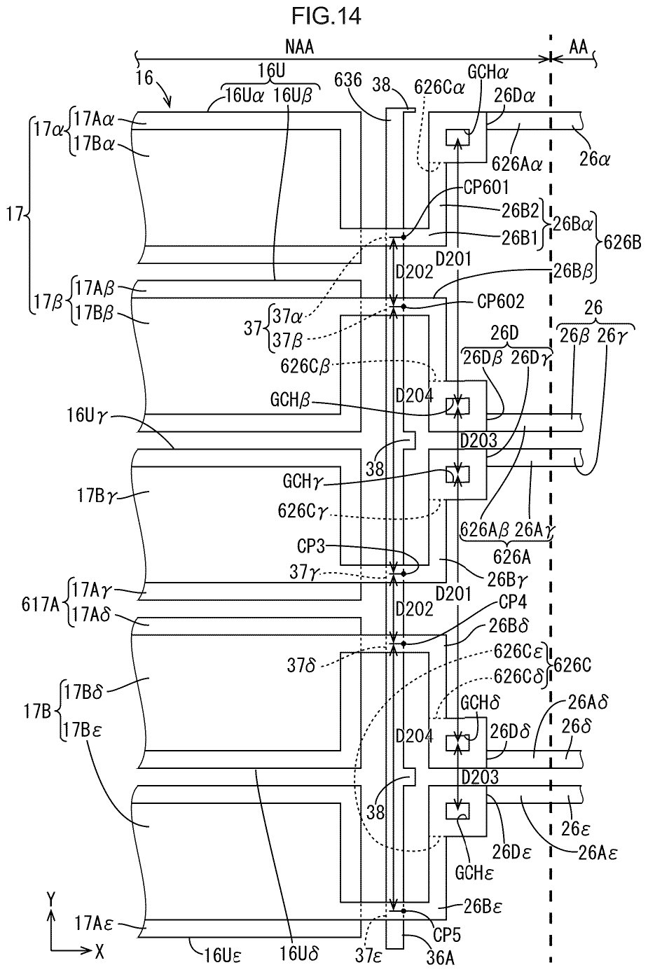

A seventh embodiment will be described with reference to FIG. 14. The seventh embodiment includes a common main line 636 that differs from that of the sixth embodiment. Configuration, operations, and effects similar to those of the sixth embodiment may not be described.

As illustrated in FIG. 14, the common main line 636 includes wide sections 38. The wide section 38 is a portion of the common main line 636 projecting toward a body side connection portion 626C (rightward in FIG. 14) in the X-axis direction. The wide sections 38 of the common main line 636 are closer to the body side connection portions 626C than the crossing portions CP is with respect to the Y-axis direction. Specifically, the wide section 38 is disposed such that the distance between the wide section 38 and the crossing portion CP is maximized and the distance between the wide section 38 and the body side connection portion 626C is minimized.

Specifically, as illustrated in FIG. 14, the wide sections 38 are disposed on the common main line 636 at intervals in the Y-axis direction. One of the wide sections 38 is on an opposite side from a first crossing portion CP601 with respect to a first body side connection portion 626Cα in the Y-axis direction. Another one of the wide sections 38 is between a second body side connection portion 626Cβ and a third body side connection portion 626Cγ with respect to the Y-axis direction. Other one of the wide sections 38 is between a fourth body side connection portion 626Cδ and a fifth body side connection portion 626Cε with respect to the Y-axis direction. Generally, some of the wide sections 38 are between the 2nth body side connection portion 626C from the upper end in FIG. 14 and the (2n+1)th body side connection portion 626C (n: natural number).

With such a configuration, if the gate body portion 626A, which is a portion of the first metal film, is charged, electrostatic discharge first occurs between the body side connection portion 626C and the wide section 38. Therefore, electrostatic breakdown is less likely to occur in the crossing portion CP. With electrostatic breakdown being less likely to occur in the crossing portion CP, short circuit is less likely to be caused between a gate extending portion 626B and a lower layer electrode 617A. Even if electrostatic discharge occurs between the body side connection portion 626C and the wide section 38, the wide section 38 has a single layer structure and does not overlap other lines and electrodes and therefore, short circuit is less likely to be caused with respect to the common main line 636.

As previously described, according to this embodiment, the common main line 636 includes the wide sections 38 that project toward the first body side connection portion 626Cα and the second body side connection portion 626Cβ in the second direction. One of the wide sections 38 projecting toward the first body side connection portion 626Cα is closer to the first body side connection portion 626Cα than the first crossing portion CP601 is. One of the wide sections 38 projecting toward the second body side connection portion 626Cβ is closer to the second body side connection portion 626Cβ than the second crossing portion CP602 is. The wide sections 38 of the common main line 636 are closer to the first body side connection portion 626Cα and the second body side connection portion 626Cβ than the first crossing portion CP601 and the second crossing portion CP602 are. Therefore, if the first gate body portion 626Aα and the second gate body portion 626Aβ, which are portions of the first metal film, are charged, electrostatic discharge first occurs between the first gate body portion 626Aα or the second gate body portion 626Aβ and the wide section 38. Therefore, electrostatic breakdown is less likely to occur in the first crossing portion CP601 and the second crossing portion CP602.

### Eighth Embodiment

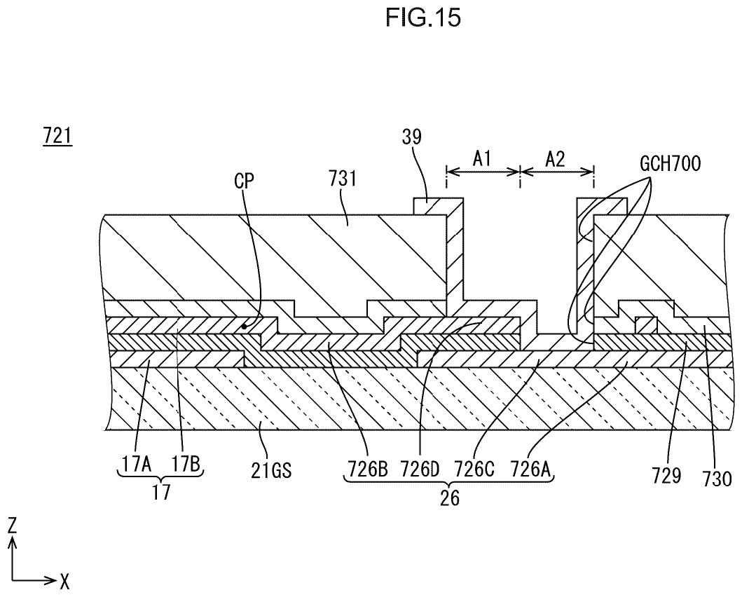

An eighth embodiment will be described with reference to FIG. 15. The eighth embodiment includes a connection structure of a gate body portion 726A and a gate extending portion 726B that differs from that of the first embodiment. Configuration, operations, and effects similar to those of the first embodiment may not be described.

As illustrated in FIG. 15, an array substrate 721 of this embodiment includes a connection electrode 39 for connecting a gate body portion 726A and a gate extending portion 726B. In this embodiment, a body side connection portion 726C of the gate body portion 726A and an extending side connection portion 726D of the gate extending portion 726B are not directly connected but connected via the connection electrode 39. In this embodiment, the entire area of the extending side connection portion 726D overlaps the body side connection portion 726C; however, a portion of the body side connection portion 726C does not overlap the extending side connection portion 726D. The connection electrode 39 is a portion of the first transparent electrode film that is different from the portion of the first transparent electrode film configured as the common electrode 28 (refer to FIG. 5) in a layer upper than a planarization film 731. The connection electrode 39 overlaps the body side connection portion 726C and the extending side connection portion 726D. A gate insulating film 729, a first interlayer insulating film 730, and the planarization film 731, which are disposed in layers lower than the connection electrode 39, include gate contact holes GCH700 that are communicated with each other. The gate contact holes GCH700 include a first area A1 that overlaps the extending side connection portion 726D and a second area A2 that overlaps the body side connection portion 726C and does not overlap the extending side connection portion 726D. The first area A1 of the gate contact holes GCH700 is in the first interlayer insulating film 730 and the planarization film 731. The connection electrode 39 and the extending side connection portion 726D are connected via the gate contact holes GCH700 in the first area A1. The gate contact holes GCH700 in the gate insulating film 729, the first interlayer insulating film 730, and the planarization film 731 are communicated in the second area A2. The connection electrode 39 and the body side connection portion 726C are connected via the gate contact holes GCH700 in the second area A2.

### Ninth Embodiment

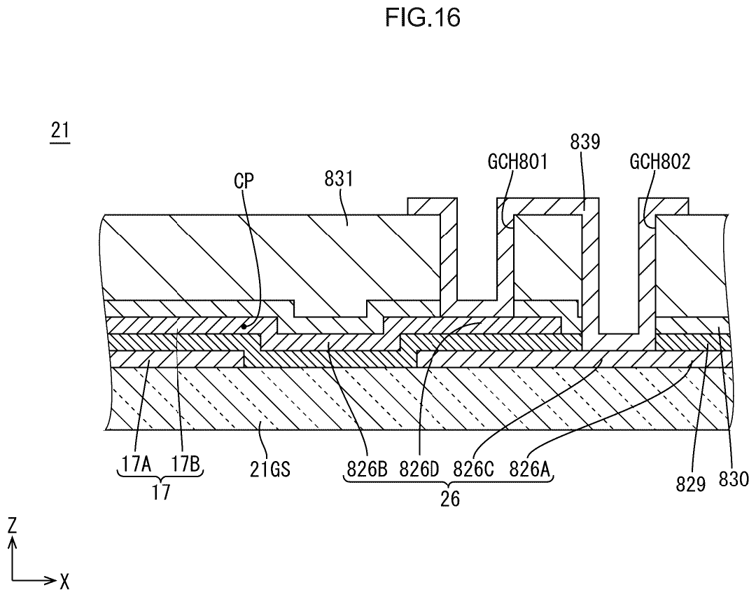

A ninth embodiment will be described with reference to FIG. 16. The ninth embodiment includes a connection structure of a gate body portion 826A and a gate extending portion 826B that differs from that of the eighth embodiment. Configuration, operations, and effects similar to those of the eighth embodiment may not be described.

As illustrated in FIG. 16, a connection electrode 839 is connected to an extending side connection portion 826D of the gate extending portion 826B and connected to a body side connection portion 826C of the gate body portion 826A via two gate contact holes GCH801 and GCH802. A first interlayer insulating film 830 and a planarization film 831, which are disposed between the connection electrode 839 and the extending side connection portion 826D, include a first gate contact hole GCH801. The first gate contact hole GCH801 overlaps the connection electrode 839 and the extending side connection portion 826D. The connection electrode 839 and the extending side connection portion 826D are connected via the first gate contact hole GCH801. A gate insulating film 829, the first interlayer insulating film 830, and the planarization film 831, which are disposed between the connection electrode 839 and the body side connection portion 826C, include a second gate contact hole GCH802. The second gate contact hole GCH802 overlaps the connection electrode 839 and the body side connection portion 826C in a portion away from the first gate contact hole GCH801. The second gate contact hole GCH802 does not overlap the extending side connection portion 826D. The connection electrode 839 and the body side connection portion 826C are connected via the second gate contact hole GCH802.

### Other Embodiments

The technology described herein is not limited to the embodiments described above and illustrated by the drawings. For example, the following embodiments will be included in the technical scope of the present technology.
(1) The gate extending portion 26B, 126B, 226B, 426B, 526B, 626B, 726B, 826B may have a plan view shape other than the L-shape. For instance, the extending portion 26B2, 426B2 of the gate extending portion 26B, 126B, 226B, 426B, 526B, 626B, 726B, 826B may extend in an oblique direction with respect to the X-axis direction and the Y-axis direction. The gate extending portion 26B, 126B, 226B, 426B, 526B, 626B, 726B, 826B may extend in an oblique direction with respect to the X-axis direction and the Y-axis direction from the upper layer electrode 17B, 117B, 217B, 317B to the extending side connection portion 26D, 126D, 226D, 326D, 526D, 726D, 826D.
(2) The gate extending portion 26B, 126B, 226B, 426B, 526B, 626B, 726B, 826B may be bent in the opposite direction from the direction illustrated in the plan view drawing. The extending portion 26B2, 426B2 may extend from the crossing portion 26B1, 426B1 in the opposite direction from the direction illustrated in the drawing. Specifically, the extending portion 26B2, 426B2 of the first gate extending portion 26Bα, 126Bα, 226Bα, 426Bα, 526Bα may extend downward in the corresponding plan view drawing, the extending portion 26B2, 426B2 of the second gate extending portion 26Bβ, 126Bβ, 226Bβ, 426Bβ, 526Bβ may extend upward in the corresponding plan view drawing, the extending portion 26B2, 426B2 of the third gate extending portion 26Bγ, 126Bγ, 226Bγ, 426Bγ, 526Bγ may extend downward in the corresponding plan view drawing, the extending portion 26B2, 426B2 of the fourth gate extending portion 26Bδ, 126Bδ, 226Bδ, 426Bδ, 526Bδ may extend upward in the corresponding plan view drawing, and the extending portion 26B2, 426B2 of the fifth gate extending portion 26Bε, 126Bε, 226Bε, 426Bε, 526Bε may extend downward in the corresponding plan view drawing.
(3) With the configuration of (2) being applied to the configuration of the fifth embodiment, the first bent portion 34α may extend downward in FIG. 10, the second bent portion 34β may extend upward, the third bent portion 34γ may extend downward in FIG. 10, the fourth bent portion 34δ may extend upward in FIG. 10, and the fifth bent portion 34ε may extend downward in FIG. 10.
(4) The portion of the upper layer electrode 17B, 117B, 217B, 317B with respect to the Y-axis direction that is connected to the gate extending portion 26B, 126B, 226B, 426B, 526B, 626B, 726B, 826B may be altered as appropriate from that illustrated in the drawing.
(5) The position of the body side connection portion 26C, 126C, 226C, 326C, 426C, 526C, 626C, 726C, 826C and the extending side connection portion 26D, 126D, 226D, 326D, 426D, 526D, 626D, 726D, 826D with respect to the Y-axis direction may be altered as appropriate from that illustrated in the drawings. The position of the body side connection portion 26C, 126C, 226C, 326C, 426C, 526C, 626C, 726C, 826C and the extending side connection portion 26D, 126D, 226D, 326D, 426D, 526D, 626D, 726D, 826D with respect to the X-axis direction may be altered as appropriate from that illustrated in the drawings.
(6) The gate lines 26, 126, 226, 426, 526 may include three types of gate lines that are different such that the portion of the upper layer electrode 17B, 117B, 217B, 317B with respect to the Y-axis direction connected to the gate extending portion 26B, 126B, 226B, 426B, 526B, 626B, 726B, 826B is different and the position of the body side connection portion 26C, 126C, 226C, 326C, 426C, 526C, 626C, 726C, 826C and the extending side connection portion 26D, 126D, 226D, 326D, 426D, 526D, 626D, 726D, 826D with respect to the Y-axis direction is different.
(7) In the configuration of the fourth embodiment, the arrangement of the projection portion 33 with respect to the Y-axis direction may be altered from that illustrated in the drawing.
(8) In the configuration of the sixth embodiment and the seventh embodiment, the width of the frame portion 36A of the common main line 36 may be altered from that illustrated in the drawing. The position relation of the frame portion 36A and the shift resistor circuit 16, 516, the body side connection portion 26C, 126C, 226C, 326C, 426C, 526C, 626C, 726C, 826C, and the extending side connection portion 26D, 126D, 226D, 326D, 426D, 526D, 626D, 726D, 826D with respect to the X-axis direction may be altered from that illustrated in the drawing.
(9) In the configuration of the seventh embodiment, the arrangement of the wide section 38 with respect to the Y-axis direction may be altered as appropriate from that illustrated in the drawing.
(10) The circuit element of the unit circuit 16U may include a TFT in addition to the capacitor 17 and an electrode of the TFT may correspond to the conductive portion that crosses the gate extending portion 26B, 126B, 226B, 426B, 526B, 626B, 726B, 826B.
(11) The pixel electrodes 25 may be portions of the first transparent electrode film and the common electrode 28 may be a portion of the second transparent electrode film. In such a configuration, the common electrode 28 preferably includes slits for controlling alignment.
(12) The driver 12 may be mounted on the flexible substrate 13 through the chip-on-film (COF) technology.
(13) The planar shape of the liquid crystal panel 11, 511 may be vertically elongated rectangle, a square, a circle, a semicircle, a vertically elongated oval, an oval, or a trapezoid.
(14) The material of the semiconductor film included in the array substrate 21 may be polycrystalline polysilicon material.
(15) The display mode of the liquid crystal panel 11, 511 may be the TN (twisted nematic) mode, the VA (vertical alignment) mode, and the IPS (in-plane switching) mode in addition to the FFS mode.
(16) Display panels other than the liquid crystal panel 11, 511 such as organic electro luminescence (EL) display panels and microcapsule-based electrophoretic display (EPD) panels may be used.
(17) The configurations of the embodiments may be combined as appropriate.
(18) In the configuration of the eighth embodiment and the ninth embodiment, the body side connection portion 726C, 826C and the extending side connection portion 726D, 826D may not overlap.
(19) In the configuration of the eighth embodiment and the ninth embodiment, the connection electrode 39, 839 may be a portion of the second transparent electrode film.

1. A wiring substrate comprising:
a first line;
a first conductive portion that crosses a portion of the first line;
a second line that is disposed to be spaced from the first line with respect to a first direction; and
a second conductive portion that crosses a portion of the second line, wherein
the first line includes a first line portion that is a portion of a first conductive film and a second line portion that is a portion of a second conductive film with having a first insulating film between the first conductive film and the second conductive film,
the first line portion includes a first end portion,
the second line portion includes a second end portion that is connected to the first end portion,
the first conductive portion is a portion of the first conductive film,
the first conductive portion crosses the second line portion of the first line at a first crossing portion,
the second line includes a third line portion that is a portion of the first conductive film and a fourth line portion that is a portion of the second conductive film,
the third line portion includes a third end portion that is away from the first end portion in the first direction with having a first distance between the third end portion and the first end portion,
the fourth line portion includes a fourth end portion that is connected to the third end portion,
the second conductive portion is a portion of the first conductive film,
the second conductive portion crosses the fourth line portion of the second line at a second crossing portion,
the fourth line portion includes the second crossing portion that is away from the first crossing portion in the first direction with having a second distance between the second crossing portion and the first crossing portion, and
the second distance differs from the first distance.

2. The wiring substrate according to claim 1, further comprising:
a third line that is spaced from the second line to be away from the first line in the first direction; and
a third conductive portion that crosses a portion of the third line, wherein
the third line includes a fifth line portion that is a portion of the first conductive film and a sixth line portion that is a portion of the second conductive film,
the fifth line portion includes a fifth end portion that is away from the third end portion in the first direction with having a third distance between the fifth end portion and the third end portion,
the sixth line portion includes a sixth end portion that is connected to the fifth end portion,
the third conductive portion is a portion of the first conductive film,
the third conductive portion crosses the sixth line portion of the third line at a third crossing portion,
the sixth line portion includes the third crossing portion that is away from the second crossing portion in the first direction with having a fourth distance between the second crossing portion and the third crossing portion, and
the fourth distance differs from the third distance.

3. The wiring substrate according to claim 2, wherein the first line, the second line, and the third line are arranged such that the first distance differs from the third distance and the second distance is equal to the fourth distance.

4. The wiring substrate according to claim 3, further comprising:
a fourth conductive portion that is a portion of the second conductive film and continuous to the second line portion;
a fifth conductive portion that is a portion of the second conductive film and continuous to the fourth line portion and spaced from the fourth conductive portion in the first direction; and
a sixth conductive portion that is a portion of the second conductive film and continuous to the sixth line portion and spaced from the fifth conductive portion to be away from the fourth conductive portion in the first direction, wherein
the first end portion and the second end portion of the first line are disposed locally in an area corresponding to the fourth conductive portion to be away from the fifth conductive portion with respect to the first direction,
the third end portion and the fourth end portion of the second line are disposed locally in an area corresponding to the fifth conductive portion to be away from the fourth conductive portion with respect to the first direction, and
the fifth end portion and the sixth end portion of the third line are disposed locally in an area corresponding to the sixth conductive portion to be close to the fifth conductive portion with respect to the first direction.

5. The wiring substrate according to claim 2, wherein the first line, the second line, and the third line are arranged such that the first distance differs from the third distance and the second distance differs from the fourth distance.

6. The wiring substrate according to claim 5, further comprising:
a fourth conductive portion that is a portion of the second conductive film and continuous to the second line portion;
a fifth conductive portion that is a portion of the second conductive film and continuous to the fourth line portion and spaced from the fourth conductive portion in the first direction; and
a sixth conductive portion that is a portion of the second conductive film and continuous to the sixth line portion and spaced from the fifth conductive portion to be away from the fourth conductive portion in the first direction, wherein
the first end portion and the second end portion of the first line are disposed locally in an area corresponding to the fourth conductive portion to be away from the fifth conductive portion with respect to the first direction and the first line is disposed such that the first crossing portion is disposed locally in the area corresponding to the fourth conductive portion to be closer to the fifth conductive portion with respect to the first direction,
the third end portion and the fourth end portion of the second line are disposed locally in an area corresponding to the fifth conductive portion to be away from the fourth conductive portion with respect to the first direction and the second line is disposed such that the second crossing portion is disposed locally in the area corresponding to the fifth conductive portion to be closer to the fourth conductive portion with respect to the first direction, and
the fifth end portion and the sixth end portion of the third line are disposed locally in an area corresponding to the sixth conductive portion to be close to the fifth conductive portion with respect to the first direction and the third line is disposed such that the third crossing portion is disposed locally in the area corresponding to the sixth conductive portion to be away from the fifth conductive portion with respect to the first direction.

7. The wiring substrate according to claim 5, wherein
the first line portion includes
a first bent portion that extends from the first end portion along a second direction crossing the first direction to be away from the first conductive portion and is subsequently bent to extend along the first direction, and
a first extending portion that extends from an end of the first bent portion along the second direction to be away from the first end portion,
the third line portion includes
a second bent portion that extends from the third end portion along the second direction to be away from the second conductive portion and is subsequently bent to extend along the first direction, and
a second extending portion that extends from an end of the second bent portion along the second direction to be away from the third end portion,
the fifth line portion includes
a third bent portion that extends from the fifth end portion along the second direction to be away from the third conductive portion and is subsequently bent to extend along the first direction, and
a third extending portion that extends from an end of the third bent portion along the second direction to be away from the fifth end portion, and
the first line portion, the third line portion, and the fifth line portion are disposed such that a fifth distance between the first extending portion and the second extending portion with respect to the first direction and a sixth distance between the second extending portion and the third extending portion with respect to the first direction are same.

8. The wiring substrate according to claim 2, wherein the first line, the second line, and the third line are arranged such that the second distance differs from the fourth distance and the first distance and the third distance are same.

9. The wiring substrate according to claim 8, further comprising:
a fourth conductive portion that is a portion of the second conductive film and continuous to the second line portion;
a fifth conductive portion that is a portion of the second conductive film and continuous to the fourth line portion and spaced from the fourth conductive portion in the first direction; and
a sixth conductive portion that is a portion of the second conductive film and continuous to the sixth line portion and spaced from the fifth conductive portion to be away from the fourth conductive portion in the first direction, wherein
the first line is disposed such that the first crossing portion is disposed locally in an area corresponding to the fourth conductive portion to be closer to the fifth conductive portion with respect to the first direction,
the second line is disposed such that the second crossing portion is disposed locally in an area corresponding to the fifth conductive portion to be closer to the fourth conductive portion with respect to the first direction, and
the third line is disposed such that the third crossing portion is disposed locally in an area corresponding to the sixth conductive portion to be away from the fifth conductive portion with respect to the first direction.

10. The wiring substrate according to claim 1, further comprising a shift resistor circuit that includes a first unit circuit connected to the second line portion and a second unit circuit connected to the fourth line portion, wherein
the first unit circuit includes the first conductive portion and the second unit circuit includes the second conductive portion, and
the first conductive portion and the second conductive portion are arranged at an interval in the first direction.

11. The wiring substrate according to claim 10, wherein
the first conductive portion includes a first projection portion that projects toward the first end portion in a second direction that crosses the first direction,
a distance between the first projection portion and the first end portion is shorter than a distance between the first crossing portion and the first end portion,
the second conductive portion includes a second projection portion that projects toward the third end portion in the second direction, and
a distance between the second projection portion and the third end portion is shorter than a distance between the second crossing portion and the third end portion.

12. The wiring substrate according to claim 1, further comprising:
a shift resistor circuit that includes a first unit circuit connected to the second line portion and a second unit circuit connected to the fourth line portion; and
a fourth line that extends along the first direction between the shift resistor circuit and the each of the first end portion and the third end portion with respect to a second direction crossing the first direction, wherein
the fourth line is a portion of the first conductive film,
the first conductive portion is a portion of the fourth line that crosses the second line portion, and
the second conductive portion is a portion of the fourth line that crosses the fourth line portion.

13. The wiring substrate according to claim 12, wherein
the fourth line includes wide sections that project toward the first end portion and the third end portion, and
one of the wide sections projecting toward the first end portion is closer to the first end portions than the first crossing portion is and another one of the wide sections projecting toward the third end portion is closer to the third end portion than the second crossing portion is.

14. A display device comprising:
the wiring substrate according to claim 1; and
an opposed substrate disposed to face and spaced from the wiring substrate.
